(19) United States
(12) Patent Application Publication
(10) Pub. No.: US 2025/0191605 A1
(43) Pub. Date: Jun. 12, 2025

(54) PHASE DIFFERENCE SPECTRUM ESTIMATION METHOD, INTER-CHANNEL RELATIONSHIP INFORMATION ESTIMATION METHOD, SIGNAL ENCODING METHOD, SIGNAL PROCESSING METHOD, APPARATUSES THEREFOR, AND PROGRAM

(71) Applicant: NIPPON TELEGRAPH AND TELEPHONE CORPORATION, Tokyo (JP)

(72) Inventors: Takehiro MORIYA, Tokyo (JP); Yutaka KAMAMOTO, Tokyo (JP); Ryosuke SUGIURA, Tokyo (JP)

(73) Assignee: NIPPON TELEGRAPH AND TELEPHONE CORPORATION, Tokyo (JP)

(21) Appl. No.: 18/837,558

(22) PCT Filed: Feb. 17, 2022
(86) PCT No.: PCT/JP2022/006318

§ 371 Date: Aug. 9, 2024

(51) Int. Cl. G10L 25/18; G10L 19/008; G10L 19/02

(52) U.S. Cl. CPC G10L 25/18; G10L 19/008; G10L 19/0204

(57) ABSTRACT

Provided is a technique for estimating a phase difference spectrum of signals of two channels by processing suitable for fixed-point operation with a smaller amount of arithmetic processing than before. Provided is a phase difference spectrum estimation method for estimating a phase difference spectrum ϕ(k) of a frequency spectrum X₁(k) of an input signal of a first channel and a frequency spectrum X₂(k) of an input signal of a second channel with respect to a frequency k, and the phase difference spectrum estimation method includes: a phase difference spectrum estimation step of selecting one of a plurality of phase difference spectrum representative values, the representative values being stored in a representative value storage unit, being values on a circumference of a unit circle of a complex plane, and being values having different arguments on the complex plane, on a basis of a relationship between a value of a real part u(k) and a value of an imaginary part v(k) of a product Y(k) of the frequency spectrum X₁(k) of the first channel and a complex conjugate ⁻X₂(k) of the frequency spectrum X₂(k) of the second channel, and obtaining the selected representative value as the phase difference spectrum ϕ(k).

### TECHNICAL FIELD

The present invention relates to a technique for obtaining a phase difference spectrum of signals of two channels in order to mix, encode, and process the signals of the two channels by using a relationship between the signals of the two channels.

### BACKGROUND ART

As a technique for obtaining a phase difference spectrum of sound signals of two channels, there is a technique described in Patent Literature 1. Patent Literature 1 mainly describes a technique for obtaining one sound signal by mixing sound signals of a plurality of channels. Specifically, Patent Literature 1 describes a technique for obtaining a value representing the magnitude of correlation between input sound signals of two channels and which of the input sound signals of the two channels is preceding, and obtaining a downmixed signal by weighting and adding the input sound signals of the two channels such that the input sound signal of the preceding channel between the input sound signals of the two channels is included larger as the value representing the magnitude of correlation is larger. Patent Literature 1 describes a technique for obtaining a time difference between input sound signals of two channels in order to obtain which of the input sound signals of the two channels is preceding. As an example of a technique for obtaining a time difference between input sound signals of two channels, a technique for obtaining a phase difference spectrum in a frequency domain of the input sound signals of the two channels, obtaining a phase difference signal for each time difference by performing inverse Fourier transform in which each time difference as a candidate is given to the phase difference spectrum, and obtaining a time difference having the largest phase difference signal among the candidate time differences as the time difference between the input sound signals of the two channels. According to this technique, it is possible to obtain the time difference between the sound signals of the two channels so as not to be affected by a harmonic structure and a pitch component of the sound signals as much as possible by using the phase difference spectrum of each frequency of the sound signals of the two channels. That is, the technique for obtaining the phase difference spectrum of the sound signals of the two channels described in Patent Literature 1 is a technique useful in applications of obtaining a time difference between sound signals of two channels, obtaining which of the sound signals of the two channels is preceding, and mixing, encoding, and processing the signals by using any of these relationship between the sound signals of the two channels.

### CITATION LIST

### Patent Literature

Patent Literature 1: WO 2021/181974 A

### SUMMARY OF INVENTION

### Technical Problem

To obtain the phase difference spectrum of the signals of the two channels by the technique described in Patent Literature 1, it is necessary to divide some value by a square root of a sum of squares of a real part and an imaginary part for each complex spectrum with respect to each frequency. In a case where the value of the sum of squares has a large possible range and processing of obtaining the value of the sum of squares is performed by a general-purpose or dedicated processor, it is necessary to perform a floating-point operation with large power consumption or perform a fixed-point operation with a large amount of arithmetic processing involving additional processing such as digit matching. In addition, to perform the calculation of the square root and the division by the processor, for example, processing of about 30 times of addition/subtraction is required. Therefore, the technique for obtaining a phase difference spectrum of signals of two channels described in Patent Literature 1 has a problem that the power consumption is large and/or the amount of arithmetic processing is large when implemented by a processor. In other words, the technique for obtaining a phase difference spectrum of signals of two channels described in Patent Literature 1 has a problem that the amount of arithmetic processing is large and the technique is not suitable for a fixed-point operation.

An object of the present invention is to provide a technique for estimating a phase difference spectrum of signals of two channels by processing suitable for fixed-point operation with a smaller amount of arithmetic processing than before.

### Solution to Problem

One aspect of the present invention is a phase difference spectrum estimation method for estimating a phase difference spectrum ϕ(k) of a frequency spectrum X₁(k) of an input signal of a first channel and a frequency spectrum X₂(k) of an input signal of a second channel with respect to a frequency k, and the phase difference spectrum estimation method includes: a phase difference spectrum estimation step of selecting one of a plurality of phase difference spectrum representative values, the representative values being stored in a representative value storage unit, being values on a circumference of a unit circle of a complex plane, and being values having different arguments on the complex plane, on a basis of a relationship between a value of a real part u(k) and a value of an imaginary part v(k) of a product Y(k) of the frequency spectrum X₁(k) of the first channel and a complex conjugate ⁻X₂(k) of the frequency spectrum X₂(k) of the second channel, and obtaining the selected representative value as the phase difference spectrum ϕ(k).

One aspect of the present invention is an inter-channel relationship information estimation method including the phase difference spectrum estimation step of the phase difference spectrum estimation method, and includes: a Fourier transform step of performing Fourier transform for each of the input signal of the first channel that is a sound signal in a time domain and the input signal of the second channel that is a sound signal in a time domain to obtain the frequency spectrum X₁(k) and the frequency spectrum X₂(k) for each frequency k from 0 to T−1; a phase difference spectrum estimation step of obtaining the phase difference spectrum ϕ(k) for the each frequency k from 0 to T−1; and an inter-channel relationship information acquisition step of performing inverse Fourier transform of a sequence based on the phase difference spectra ϕ(0) to ϕ(T−1) for each candidate sample number τ_{cand} from a predetermined number τₘₐₓ to a predetermined number τₘᵢₙ to obtain a phase difference signal ψ(τ_{cand}) for the each candidate sample number τ_{cand} from τₘₐₓ to τₘᵢₙ, obtaining a maximum value of a correlation value γ_{cand} that is an absolute value of the phase difference signal ψ(τ_{cand}), and further performing at least one of obtaining and outputting the maximum value of the correlation value γ_{cand} as an inter-channel correlation value γ, obtaining and outputting τ_{cand} of when the correlation value γ_{cand} is the maximum value as an inter-channel time difference, or in a case where τ_{cand} of when the correlation value γ_{cand} is the maximum value is a positive value, obtaining information indicating that the first channel is preceding as preceding channel information, or in a case where τ_{cand} of when the correlation value γ_{cand} is the maximum value is a negative value, obtaining information indicating that the second channel is preceding as preceding channel information, and outputting the obtained preceding channel information.

One aspect of the present invention is a signal encoding method, and includes: the phase difference spectrum estimation step of the phase difference spectrum estimation method; and an encoding step of encoding the input signal of the first channel and the input signal of the second channel using the phase difference spectrum ϕ(k) obtained in the phase difference spectrum estimation step to obtain a signal code, and outputting the signal code.

One aspect of the present invention is a signal processing method, and includes: the phase difference spectrum estimation step of the phase difference spectrum estimation method; and a signal processing step of processing the input signal of the first channel and the input signal of the second channel using the phase difference spectrum ϕ(k) obtained in the phase difference spectrum estimation step to obtain a signal processing result, and outputting the signal processing result.

### Advantageous Effects of Invention

According to the present invention, it is possible to estimate a phase difference spectrum of signals of two channels by processing suitable for fixed-point operation with a smaller amount of arithmetic processing than before.

### BRIEF DESCRIPTION OF DRAWINGS

FIG. 1 is a block diagram illustrating a sound signal downmixing device 100 according to a first embodiment and a second embodiment.

FIG. 2 is a flowchart illustrating processing of the sound signal downmixing device 100 according to the first embodiment and the second embodiment.

FIG. 3 is a diagram illustrating each representative value of a first example of a phase difference spectrum estimation unit 122.

FIG. 4 is a diagram illustrating each representative value of a first quadrant of a second example of the phase difference spectrum estimation unit 122.

FIG. 5 is a block diagram illustrating an inter-channel relationship information estimation device 120 according to a third embodiment.

FIG. 6 is a flowchart illustrating processing of the inter-channel relationship information estimation device 120 according to the third embodiment.

FIG. 7 is a block diagram illustrating a phase difference spectrum estimation device 200 according to a fourth embodiment.

FIG. 8 is a flowchart illustrating processing of the phase difference spectrum estimation device 200 according to the fourth embodiment.

FIG. 9 is a block diagram illustrating a signal encoding device 300 according to a fifth embodiment.

FIG. 10 is a flowchart illustrating processing of the signal encoding device 300 according to the fifth embodiment.

FIG. 11 is a block diagram illustrating a signal processing device 400 according to a sixth embodiment.

FIG. 12 is a flowchart illustrating processing of the signal processing device 400 according to the sixth embodiment.

FIG. 13 is a diagram illustrating an example of a functional configuration of a computer that implements each device according to the embodiment of the present invention.

### DESCRIPTION OF EMBODIMENTS

### First Embodiment

In a first embodiment, a mode in which phase difference spectrum estimation processing of the present invention is applied to a sound signal downmixing device that performs downmixing processing in consideration of a relationship between a first channel input sound signal and a second channel input sound signal so as to obtain a monophonic signal useful for signal processing such as encoding processing will be described.

Two-channel sound signals to be subjected to signal processing such as encoding processing are often digital sound signals obtained by performing AD conversion for sound collected by a left-channel microphone and a right-channel microphone disposed in a certain space. In this case, what are input to a device that performs signal processing such as encoding processing are a first channel input sound signal that is a digital sound signal obtained by performing AD conversion for the sound collected by the left-channel microphone disposed in the space and a second channel input sound signal that is a digital sound signal obtained by performing AD conversion for the sound collected by the right-channel microphone disposed in the space. The first channel input sound signal and the second channel input sound signal often include the sound emitted by each sound source existing in the space in a state in which a difference (so-called arrival time difference) between an arrival time from the sound source at the left-channel microphone and an arrival time from the sound source at the right-channel microphone is given. In consideration of this fact, a sound signal downmixing device according to the first embodiment performs downmixing processing in consideration of the relationship between the first channel input sound signal and the second channel input sound signal in order to obtain a monaural signal useful for signal processing such as encoding processing. Hereinafter, the sound signal downmixing device according to a first embodiment will be described.

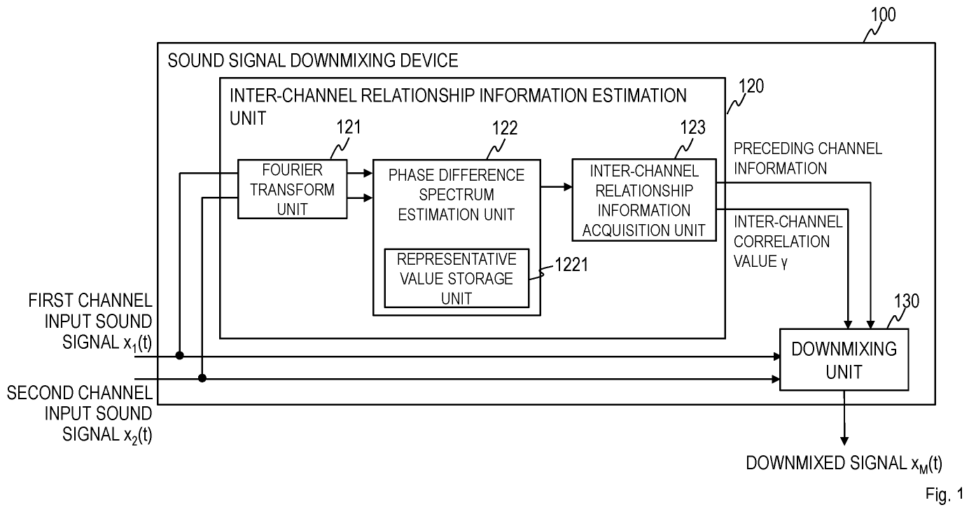

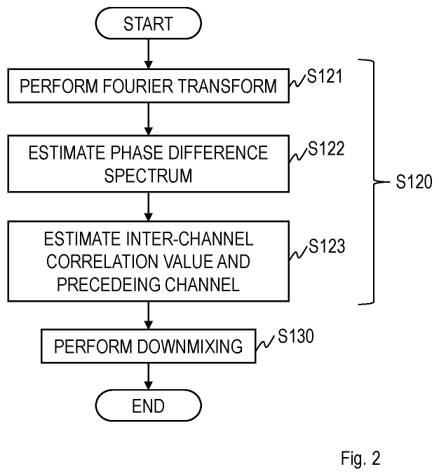

As illustrated in FIG. 1, a sound signal downmixing device 100 according to the first embodiment includes an inter-channel relationship information estimation unit 120 and a downmixing unit 130. The sound signal downmixing device 100 obtains and outputs a downmixed signal to be described below from input sound signals in a time domain of two-channel stereo in units of frames having a predetermined time length of 20 ms, for example. What are input to the sound signal downmixing device 100 are sound signals in the time domain of two-channel stereo, and are, for example, digital sound signals obtained by respectively collecting and AD-converting sound such as vocal sound and music with two microphones, digital decoded sound signals obtained by encoding and decoding the digital sound signals described above, and digital signal-processed sound signals obtained by performing signal processing for the digital sound signals described above, and includes the first channel input sound signal and the second channel input sound signal. The downmixed signal that is a monaural sound signal in the time domain obtained by the sound signal downmixing device 100 is input to a sound signal encoding device that encodes at least the downmixed signal or a sound signal processing device that performs signal processing for at least the downmixed signal. When the number of samples per frame is T, the first channel input sound signals x₁(1), x₁(2), . . . , x₁(T) and the second channel input sound signals x₂(1), x₂(2), . . . , x₂(T) are input to the sound signal downmixing device 100 in units of frames, and the sound signal downmixing device 100 obtains and outputs the downmixed signals x_{M}(1), x_{M}(2), . . . , x_{M}(T) in units of frames. Here, T is a positive integer and is, for example, 640 when a frame length is 20 ms and a sampling frequency is 32 kHz. The sound signal downmixing device 100 performs processing of steps S120 and S130 illustrated in FIG. 2 for each frame.

### [Inter-channel Relationship Information Estimation Unit 120]

The inter-channel relationship information estimation unit 120 receives the first channel input sound signal input to the sound signal downmixing device 100 and the second channel input sound signal input to the sound signal downmixing device 100. The inter-channel relationship information estimation unit 120 obtains and outputs an inter-channel correlation value γ and preceding channel information from the first channel input sound signal and the second channel input sound signal (step S120). Specifically, the processing of step S120 includes processing of steps S121 to S123 illustrated in FIG. 2. As illustrated in FIG. 1, the inter-channel relationship information estimation unit 120 includes a Fourier transform unit 121, a phase difference spectrum estimation unit 122, and an inter-channel relationship information acquisition unit 123. The Fourier transform unit 121 performs step S121, the phase difference spectrum estimation unit 122 performs step S122, and the inter-channel relationship information acquisition unit 123 performs step S123.

The preceding channel information is information indicating in which of the first channel input sound signal and the second channel input sound signal the same sound signal is included first. For example, the preceding channel information is information corresponding to at which of the left-channel microphone disposed in the space and the right-channel microphone disposed in the space sound emitted by a main sound source in the space arrives earlier. Assuming that the first channel is said to be preceding or the second channel is said to be following in a case where the same sound signal is included earlier in the first channel input sound signal, and assuming that the second channel is said to be preceding or the first channel is said to be following in a case where the same sound signal is included earlier in the second channel input sound signal, the preceding channel information is information indicating which of the first channel and the second channel is preceding. The inter-channel correlation value γ is a correlation value considering a time difference between the first channel input sound signal and the second channel input sound signal. That is, the inter-channel correlation value γ is a value representing the magnitude of the correlation between a sample sequence of the input sound signal of the preceding channel and a sample sequence of the input sound signal of the following channel at a position shifted behind the aforementioned sample sequence by τ samples. Hereinafter, this τ is also referred to as an inter-channel time difference. Since the preceding channel information and the inter-channel correlation value γ are information indicating the relationship between the first channel input sound signal and the second channel input sound signal, they can also be referred to as inter-channel relationship information.

### [Fourier Transform Unit 121]

The Fourier transform unit 121 obtains frequency spectra X₁(k) and X₂(k) at each frequency k from 0 to T−1 by performing Fourier transform for each of the first channel input sound signals x₁(1), x₁(2), . . . , x₁(T) and the second channel input sound signals x₂(1), x₂(2), . . . , x₂(T) as in following Equations (1-1) and (1-2) (step S121).

$$[ Math . 1 ]$$

$${X}_{1} ( k ) = \frac{1}{\sqrt{T}} {\sum }_{t = 0}^{T - 1} {x}_{1} ( t + 1 ) {e}^{- j \frac{2 π kt}{T}} \qquad ( 1 - 1 )$$

$$[ Math . 2 ]$$

$${X}_{2} ( k ) = \frac{1}{\sqrt{T}} {\sum }_{t = 0}^{T - 1} {x}_{2} ( t + 1 ) {e}^{- j \frac{2 π kt}{T}} \qquad ( 1 - 2 )$$

The frequency spectra X₁(k) and X₂(k) at each frequency k from 0 to T−1 obtained by the Fourier transform unit 121 are output from the Fourier transform unit 121 and input to the phase difference spectrum estimation unit 122.

### [Phase Difference Spectrum Estimation Unit 122]

First, an existing technique will be described. In Patent Literature 1, the inter-channel relationship information estimation unit 120 obtains a phase difference spectrum ϕ(k) at each frequency k by following Equation (1-3) using the frequency spectra X₁(k) and X₂(k) at each frequency k obtained by Equations (1-1) and (1-2) next to step S121.

$$[ Math . 3 ]$$

$$ϕ ( k ) = \frac{{X}_{1} ( k ) / \vert {X}_{1} ( k ) \vert}{{X}_{2} ( k ) / \vert {X}_{2} ( k ) \vert} \qquad ( 1 - 3 )$$

In a case where the processing of obtaining the phase difference spectrum ϕ(k) at each frequency k by Equation (1-3) is performed by a processor, it is assumed that Equation (1-4) below equivalent to Equation (1-3) is used. ⁻X₂(k) is a complex conjugate of X₂(k). Note that the superscript “⁻” should be described directly above the “X₂(k)”, but due to restriction of description of the specification, it is described as “⁻X₂(k)”.

$$[ Math . 4 ]$$

$$ϕ ( k ) = \frac{{X}_{1} ( k ) {\overline{X}}_{2} ( k )}{\vert {X}_{1} ( k ) \vert \vert {X}_{2} ( k ) \vert} \qquad ( 1 - 4 )$$

The processing of obtaining the phase difference spectrum ϕ(k) at each frequency k by Equation (1-4) includes, for example, first processing of calculating a product of the frequency spectrum X₁(k) and the complex conjugate ⁻X₂(k) of the frequency spectrum X₂(k), second processing of calculating |X₁(k)| and |X₂(k)|, third processing of calculating a product of |X₁(k)| and |X₂(k)|, and fourth processing of dividing the product obtained in the first processing by the product obtained in the third processing. Here, |X₁(k)| is a square root of a sum of squares of a real part X₁(k)ᵣₑₐₗ and an imaginary part X₁(k)_{imag} of the frequency spectrum X₁(k) as expressed by Equation (1-5A) below. Similarly, X₂(k)| is a square root of a sum of squares of a real part X₂(k)ᵣₑₐₗ and an imaginary part X₂(k)_{imag} of the frequency spectrum X₂(k) as expressed by Equation (1-5B) below. That is, the second processing includes square root operation twice.

$$[ Math . 5 ]$$

$$\vert {X}_{1 ( k )} \vert = \sqrt{{X}_{1} {( k )}_{real}^{2} + {X}_{1} {( k )}_{imag}^{2}} \qquad ( 1 - 5 A )$$

$$\vert {X}_{2 ( k )} \vert = \sqrt{{X}_{2} {( k )}_{real}^{2} + {X}_{2} {( k )}_{imag}^{2}} \qquad ( 1 - 5 B )$$

In a normal processor, as exemplified in the ITU-T operation conversion standard, one operation of the square root operation and the division requires about 30 times the number of clocks of one operation of product-sum operation. Therefore, since the processing of obtaining the phase difference spectrum ϕ(k) at each frequency k by Equation (1-4) includes the second processing and the fourth processing, the amount of arithmetic processing is large. It is possible to perform the square root operation once by performing the second processing and the third processing together, but in this case, it is necessary to calculate a product of an energy dimension value of X₁(k) and an energy dimension value of X₂(k). Since the energy dimension value has the magnitude of the square of a waveform value, the value of the product of the energy dimension values has the magnitude of the fourth power of the waveform value. The value having the magnitude of the fourth power of the waveform value can be calculated without performing special processing in the case of a floating-point operation with large power consumption, but in order to perform calculation with a fixed-point operation with small power consumption, it is necessary to perform additional processing such as digit matching since the range of possible values is limited. That is, the processing of obtaining the phase difference spectrum ϕ(k) at each frequency k by Equation (1-4) has a problem of a large amount of arithmetic processing and not suitable for the fixed-point operation. Therefore, the phase difference spectrum estimation unit 122 estimates a phase difference spectrum of signals of two channels by processing suitable for the fixed-point operation with a smaller amount of arithmetic processing than before, as will be described below.

Hereinafter, the following description will be given, setting the product of the frequency spectrum X₁(k) of the first channel and the complex conjugate ⁻X₂(k) of the frequency spectrum X₂(k) of the second channel, which is a numerator of the right term of the Equation (1-4), as Y(k) as in Equation (1-6A) below, the real part Y(k)ᵣₑₐₗ of Y(k) as u(k) as in Equation (1-6B) below, and the imaginary part Y(k)_{imag} of Y(k) as v(k) as in Equation (1-6C) below.

$$[ Math . 6 ]$$

$$Y ( k ) = {X}_{1} ( k ) {\overline{X}}_{2} ( k ) \qquad ( 1 - 6 A )$$

$$u ( k ) = Y {( k )}_{real} \qquad ( 1 - 6 B )$$

$$v ( k ) = Y {( k )}_{imag} \qquad ( 1 - 6 C )$$

As can be seen from the fact that in the right term of Equation (1-4), the product of the frequency spectrum X₁(k) and the complex conjugate ⁻X₂(k) of the frequency spectrum X₂(k) is divided by the product of |X₁(k)| and |X₂(k)|, the phase difference spectrum ϕ(k) exists on a circumference of a unit circle of a complex plane. Therefore, a complex value of a point at which an argument on the complex plane is the same as Y(k) and located on the circumference of the unit circle of the complex plane is the phase difference spectrum ϕ(k).

### [[First Example of Phase Difference Spectrum Estimation Unit 122]]

Since the arguments on the complex plane of Y(k) and the phase difference spectrum ϕ(k) are the same as described above, Y(k) and the phase difference spectrum ϕ(k) are in the same quadrant of the complex plane. Therefore, the phase difference spectrum estimation unit 122 of the first example selects any one of predetermined phase difference spectrum representative values of quadrants on the basis of in which quadrant Y(k) is located and obtains the selected representative value as the phase difference spectrum ϕ(k) (step S122-A).

Specifically, the phase difference spectrum estimation unit 122 obtains a predetermined phase difference spectrum representative value of a first quadrant as the phase difference spectrum ϕ(k) in a case where Y(k) is in the first quadrant of the complex plane, obtains a predetermined phase difference spectrum representative value of a second quadrant as the phase difference spectrum ϕ(k) in a case where Y(k) is in the second quadrant of the complex plane, obtains a predetermined phase difference spectrum representative value of a third quadrant as the phase difference spectrum ϕ(k) in a case where Y(k) is in the third quadrant of the complex plane, and obtains a predetermined phase difference spectrum representative value of a fourth quadrant as the phase difference spectrum ϕ(k) in a case where Y(k) is in the fourth quadrant of the complex plane.

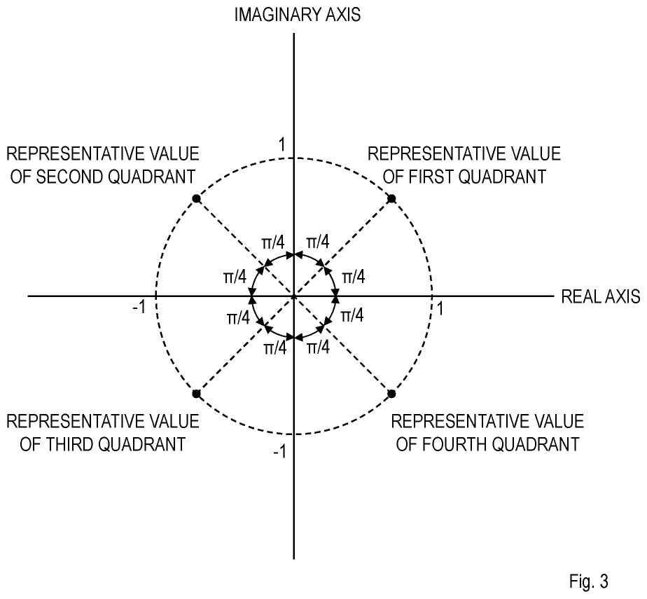

The representative value of each quadrant is predetermined and stored in a representative value storage unit 1221 in the phase difference spectrum estimation unit 122. Since the phase difference spectrum representative value of each quadrant is a value to be an estimated value of the phase difference spectrum of each quadrant, the representative value is a complex value of a point located on a circumference of a unit circle of a complex plane and at which an argument on the complex plane is a median in an argument range of each quadrant, as illustrated in FIG. 3, for example.

Since the argument range of the first quadrant is 0 to π/2, the representative value of the first quadrant is, for example, a value of a point on the circumference of the unit circle of which the argument on the complex plane is π/4. Specifically, the representative value is a value with the real part of cos (π/4) and the imaginary part of sin (π/4). Since the argument range of the second quadrant is π/2 to π, the representative value of the second quadrant is, for example, a value of a point on the circumference of the unit circle of which the argument on the complex plane is 3π/4. Specifically, the representative value is a value with the real part of cos (3π/4) and the imaginary part of sin (3π/4). Since the argument range of the third quadrant is π to 3π/2, the representative value of the third quadrant is, for example, a value of a point on the circumference of the unit circle of which the argument on the complex plane is 5π/4. Specifically, the representative value is a value with the real part of cos (5π/4) and the imaginary part of sin (5π/4). Since the argument range of the fourth quadrant is 3π/2 to 2π, the representative value of the fourth quadrant is, for example, a value of a point on the circumference of the unit circle of which the argument on the complex plane is 7π/4. Specifically, the representative value is a value with the real part of cos (7π/4) and the imaginary part of sin (7π/4).

In which quadrant of the complex plane Y(k) is located can be determined by a combination of a sign indicating whether u(k) is a positive value or a negative value and a sign indicating whether v(k) is a positive value or a negative value. Specifically, in a case where both the sign of u(k) and the sign of v(k) are signs representing positive values, Y(k) is in the first quadrant of the complex plane, in a case where the sign of u(k) is a sign representing a negative value and the sign of v(k) is a sign representing a positive value, Y(k) is in the second quadrant of the complex plane, in a case where both the sign of u(k) and the sign of v(k) are signs representing negative values, Y(k) is in the third quadrant of the complex plane, and in a case where the sign of u(k) is a sign representing a positive value and the sign of v(k) is a sign representing a negative value, Y(k) is in the fourth quadrant of the complex plane. Therefore, the phase difference spectrum estimation unit 122 obtains the predetermined phase difference spectrum representative value of the first quadrant as the phase difference spectrum ϕ(k) in the case where both the sign of u(k) and the sign of v(k) are signs representing positive values, obtains the predetermined phase difference spectrum representative value of the second quadrant as the phase difference spectrum ϕ(k) in the case where the sign of u(k) is a sign representing a negative value and the sign of v(k) is a sign representing a positive value, obtains the predetermined phase difference spectrum representative value of the third quadrant as the phase difference spectrum ϕ(k) in the case where both the sign of u(k) and the sign of v(k) are signs representing negative values, and obtains the predetermined phase difference spectrum representative value of the fourth quadrant as the phase difference spectrum ϕ(k) in the case where the sign of u(k) is a sign representing a positive value and the sign of v(k) is a sign representing a negative value. Note that, in a case where the sign indicating whether each of u(k) and v(k) is a positive value or a negative value is included as one bit (for example, the first bit) at a predetermined position in a bit string of each of u(k) and v(k) expressed by a predetermined number of bits, the phase difference spectrum estimation unit 122 can obtain the phase difference spectrum ϕ(k) by determination based on only two bits of the one bit at the predetermined position of u(k) and the one bit at the predetermined position of v(k).

Of course, instead of the combination of the sign of u(k) and the sign of v(k), it is also possible to determine in which quadrant of the complex plane Y(k) is located by a combination of whether each of u(k) and v(k) is a positive value or a negative value. Therefore, the phase difference spectrum estimation unit 122 may obtain the predetermined phase difference spectrum representative value of the first quadrant as the phase difference spectrum ϕ(k) in the case where both the u(k) and v(k) are positive values, obtain the predetermined phase difference spectrum representative value of the second quadrant as the phase difference spectrum ϕ(k) in the case where u(k) is a negative value and v(k) is a positive value, obtain the predetermined phase difference spectrum representative value of the third quadrant as the phase difference spectrum ϕ(k) in the case where both the u(k) and v(k) are negative values, and obtain the predetermined phase difference spectrum representative value of the fourth quadrant as the phase difference spectrum ϕ(k) in the case where u(k) is a positive value and v(k) is a negative value. Of course, the phase difference spectrum estimation unit 122 may determine in which quadrant of the complex plane Y(k) is located by using the sign of one of u(k) and v(k) and using whether the other is a positive value or a negative value.

Note that, in a case where Y(k) is on a boundary line of quadrants in the complex plane, the phase difference spectrum estimation unit 122 may perform step S122-A, assuming that Y(k) is in one of the quadrants sandwiching the boundary line. That is, in the case where Y(k) is on the boundary line of the quadrants in the complex plane, the phase difference spectrum estimation unit 122 may obtain the predetermined phase difference spectrum representative value of any one of the quadrants sandwiching the boundary line as the phase difference spectrum ϕ(k). Of which one of the quadrants sandwiching the boundary line the predetermined phase difference spectrum representative value is set as the phase difference spectrum ϕ(k) in the case where the Y(k) is on the boundary line of the quadrants in the complex plane may be predetermined and stored in the phase difference spectrum estimation unit 122. Specifically, in a case where Y(k) is on the boundary line between the first quadrant and the second quadrant, that is, in a case where u(k) is 0 and v(k) is a positive value, the phase difference spectrum estimation unit 122 may obtain any one of the predetermined phase difference spectrum representative value of the first quadrant and the predetermined phase difference spectrum representative value of the second quadrant as the phase difference spectrum ϕ(k). Similarly, in a case where Y(k) is on the boundary line between the second quadrant and the third quadrant, that is, in a case where u(k) is a negative value and v(k) is 0, the phase difference spectrum estimation unit 122 may obtain any one of the predetermined phase difference spectrum representative value of the second quadrant and the phase difference spectrum phase difference spectrum representative value of the third quadrant as the phase difference spectrum ϕ(k). Similarly, in a case where Y(k) is on the boundary line between the third quadrant and the fourth quadrant, that is, in a case where u(k) is 0 and v(k) is a negative value, the phase difference spectrum estimation unit 122 may obtain any one of the predetermined phase difference spectrum representative value of the third quadrant and the phase difference spectrum phase difference spectrum representative value of the fourth quadrant as the phase difference spectrum ϕ(k). Similarly, in a case where Y(k) is on the boundary line between the fourth quadrant and the first quadrant, that is, in a case where u(k) is a positive value and v(k) is 0, the phase difference spectrum estimation unit 122 may obtain any one of the predetermined phase difference spectrum representative value of the fourth quadrant and the phase difference spectrum phase difference spectrum representative value of the first quadrant as the phase difference spectrum ϕ(k).

### [[Modification of First Example of Phase Difference Spectrum Estimation Unit 122]]

In addition to step S122-A, in the case where Y(k) is on the boundary line of the quadrants in the complex plane, the phase difference spectrum estimation unit 122 may obtain a predetermined phase difference spectrum representative value in the case where Y(k) is on the boundary line of the quadrants as the phase difference spectrum ϕ(k) (step S122-A2). Specifically, in the case where Y(k) is on the boundary line between the first quadrant and the second quadrant, that is, in the case where u(k) is 0 and v(k) is a positive value, the phase difference spectrum estimation unit 122 may obtain the predetermined phase difference spectrum representative value in the case where Y(k) is on the boundary between the first quadrant and the second quadrant as the phase difference spectrum ϕ(k). Similarly, in the case where Y(k) is on the boundary line between the second quadrant and the third quadrant, that is, in the case where u(k) is a negative value and v(k) is 0, the phase difference spectrum estimation unit 122 may obtain the predetermined phase difference spectrum representative value in the case where Y(k) is on the boundary line between the second quadrant and the third quadrant as the phase difference spectrum ϕ(k). Similarly, in the case where Y(k) is on the boundary line between the third quadrant and the fourth quadrant, that is, in the case where u(k) is 0 and v(k) is a negative value, the phase difference spectrum estimation unit 122 may obtain the predetermined phase difference spectrum representative value in the case where Y(k) is on the boundary line between the third quadrant and the fourth quadrant as the phase difference spectrum ϕ(k). Similarly, in the case where Y(k) is on the boundary line between the fourth quadrant and the first quadrant, that is, in the case where u(k) is a positive value and v(k) is 0, the phase difference spectrum estimation unit 122 may obtain the predetermined phase difference spectrum representative value in the case where Y(k) is on the boundary line between the fourth quadrant and the first quadrant as the phase difference spectrum ϕ(k).

Each representative value of the phase difference spectrum in the case of being on the boundary line of the quadrant is determined in advance and stored in the representative value storage unit 1221 in the phase difference spectrum estimation unit 122. The phase difference spectrum representative value in the case where Y(k) is on the boundary line between the first quadrant and the second quadrant is, for example, a value of a point on the circumference of the unit circle of which the argument on the complex plane is π/2, and is a value with the real part of 0 and the imaginary part of 1. The phase difference spectrum representative value in the case where Y(k) is on the boundary line between the second quadrant and the third quadrant is, for example, a value of a point on the circumference of the unit circle of which the argument on the complex plane is π, and is a value with the real part of −1 and the imaginary part of 0. The phase difference spectrum representative value in the case where Y(k) is on the boundary line between the third quadrant and the fourth quadrant is, for example, a value of a point on the circumference of the unit circle of which the argument on the complex plane is 3π/2, and is a value with the real part of 0 and the imaginary part of −1. The phase difference spectrum representative value in the case where Y(k) is on the boundary line between the fourth quadrant and the first quadrant is, for example, a value of a point on the circumference of the unit circle of which the argument on the complex plane is 0, and is a value with the real part of 1 and the imaginary part of 0.

### [[Second Example of Phase Difference Spectrum Estimation Unit 122]]

The argument of the phase difference spectrum estimated by the phase difference spectrum estimation unit 122 of the first example has an error of π/4 at the maximum. The phase difference spectrum estimation unit 122 of the second example estimates the phase difference spectrum with less error than the phase difference spectrum estimation unit 122 of the first example. The phase difference spectrum estimation unit 122 of the second example selects any one of a predetermined phase difference spectrum representative value of a half region on a real axis side of each quadrant and a predetermined phase difference spectrum representative value of a half region on an imaginary axis side of each quadrant on the basis of in which quadrant Y(k) is located and in which of the half region on the real axis side and the half region on the imaginary axis side of the quadrant Y(k) is located, and obtains the selected representative value as the phase difference spectrum ϕ(k) (step S122-B).

Specifically, the phase difference spectrum estimation unit 122 obtains the predetermined phase difference spectrum representative value of the half region on the real axis side of the first quadrant as the phase difference spectrum ϕ(k) in a case where Y(k) is in the half region on the real axis side of the first quadrant in the complex plane, obtains the predetermined phase difference spectrum representative value of the half region on the imaginary axis side of the first quadrant as the phase difference spectrum ϕ(k) in a case where Y(k) is in the half region on the imaginary axis side of the first quadrant in the complex plane, obtains the predetermined phase difference spectrum representative value of the half region on the real axis side of the second quadrant as the phase difference spectrum ϕ(k) in a case where Y(k) is in the half region on the real axis side of the second quadrant in the complex plane, obtains the predetermined phase difference spectrum representative value of the half region on the imaginary axis side of the second quadrant as the phase difference spectrum ϕ(k) in a case where Y(k) is in the half region on the imaginary axis side of the second quadrant in the complex plane, obtains the predetermined phase difference spectrum representative value of the half region on the real axis side of the third quadrant as the phase difference spectrum ϕ(k) in a case where Y(k) is in the half region on the real axis side of the third quadrant in the complex plane, obtains the predetermined phase difference spectrum representative value of the half region on the imaginary axis side of the third quadrant as the phase difference spectrum ϕ(k) in the case where Y(k) is in the half region on the imaginary axis side of the third quadrant in the complex plane, obtains the predetermined phase difference spectrum representative value of the half region on the real axis side of the fourth quadrant as the phase difference spectrum ϕ(k) in a case where Y(k) is in the half region on the real axis side of the fourth quadrant of the complex plane, and obtains the predetermined phase difference spectrum representative value of the half region on the imaginary axis side of the fourth quadrant as the phase difference spectrum ϕ(k) in a case where Y(k) is in the half region on the imaginary axis side of the fourth quadrant in the complex plane.

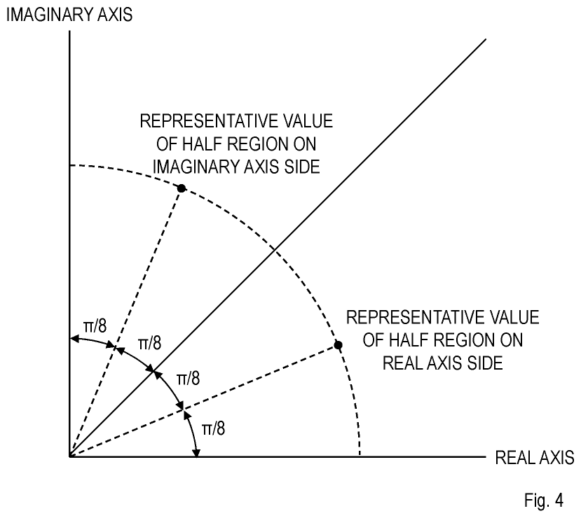

The phase difference spectrum representative value in each region is predetermined and stored in the representative value storage unit 1221 in the phase difference spectrum estimation unit 122. Since the phase difference spectrum representative value of each region is a value to be an estimated value of the phase difference spectrum of each region, the representative value is a complex value of a point located on a circumference of a unit circle of a complex plane and at which an argument on the complex plane is a median in an argument range of each region, as illustrated in FIG. 4 for the first quadrant, for example.

Since the argument range of the half region on the real axis side of the first quadrant is 0 to π/4, the phase difference spectrum representative value of the half region on the real axis side of the first quadrant is, for example, a value of a point on the circumference of the unit circle of which the argument on the complex plane is π/8. Specifically, the representative value is a value with the real part of cos (π/8) and the imaginary part of sin (π/8). Since the argument range of the half region on the imaginary axis side of the first quadrant is π/4 to π/2, the phase difference spectrum representative value of the half region on the imaginary axis side of the first quadrant is, for example, a value of a point on the circumference of the unit circle of which the argument on the complex plane is 3π/8. Specifically, the representative value is a value with the real part of cos (3π/8) and the imaginary part of sin (3π/8).

Since the argument range of the half region on the real axis side of the second quadrant is 3π/4 to π, the phase difference spectrum representative value of the half region on the real axis side of the second quadrant is, for example, a value of a point on the circumference of the unit circle of which the argument on the complex plane is 7π/8. Specifically, the representative value is a value with the real part of cos (7π/8) and the imaginary part of sin (7π/8). Since the argument range of the half region on the imaginary axis side of the second quadrant is π/2 to 3π/4, the phase difference spectrum representative value of the half region on the imaginary axis side of the second quadrant is, for example, a value of a point on the circumference of the unit circle of which the argument on the complex plane is 5π/8. Specifically, the representative value is a value with the real part of cos (5π/8) and the imaginary part of sin (5π/8).

Since the argument range of the half region on the real axis side of the third quadrant is π to 5π/4, the phase difference spectrum representative value of the half region on the real axis side of the third quadrant is, for example, a value of a point on the circumference of the unit circle of which the argument on the complex plane is 9π/8. Specifically, the representative value is a value with the real part of cos (9π/8) and the imaginary part of sin (9π/8). Since the argument range of the half region on the imaginary axis side of the third quadrant is 5π/4 to 3π/2, the phase difference spectrum representative value of the half region on the imaginary axis side of the third quadrant is, for example, a value of a point on the circumference of the unit circle of which the argument on the complex plane is 11π/8. Specifically, the representative value is a value with the real part of cos (11π/8) and the imaginary part of sin (11π/8).

Since the argument range of the half region on the real axis side of the fourth quadrant is 7π/4 to 2π, the phase difference spectrum representative value of the half region on the real axis side of the fourth quadrant is, for example, a value of a point on the circumference of the unit circle of which the argument on the complex plane is 15π/8. Specifically, the representative value is a value with the real part of cos (15π/8) and the imaginary part of sin (15π/8). Since the argument range of the half region on the imaginary axis side of the fourth quadrant is 3π/2 to 7π/4, the phase difference spectrum representative value of the half region on the imaginary axis side of the fourth quadrant is, for example, a value of a point on the circumference of the unit circle of which the argument on the complex plane is 13π/8. Specifically, the representative value is a value with the real part of cos (13π/8) and the imaginary part of sin (13π/8).

Regardless of in which quadrant Y(k) is located, Y(k) is in the half region on the real axis side of the quadrant in a case where an absolute value |u(k)| of the real part of Y(k) is larger than an absolute value |v(k)| of the imaginary part of Y(k), and Y(k) is in the half region on the imaginary axis side of the quadrant in a case where the absolute value |u(k)| of the real part of Y(k) is smaller than the absolute value |v(k)| of the imaginary part of Y(k). That is, whether Y(k) is in the half region on the real axis side of the quadrant or in the half region on the imaginary axis side of the quadrant can be determined by which one of |u(k)| and |v(k)| is larger. Therefore, the phase difference spectrum estimation unit 122 of the second example may obtain any one of the predetermined phase difference spectrum representative value of the half region on the real axis side of each quadrant and the predetermined phase difference spectrum representative value of the half region on the imaginary axis side of each quadrant as the phase difference spectrum ϕ(k) on the basis of in which quadrant Y(k) is located and which one of the absolute value |u(k)| of the real part of Y(k) and the absolute value |v(k)| of the imaginary part of Y(k) is larger.

Specifically, the phase difference spectrum estimation unit 122 obtains the predetermined phase difference spectrum representative value of the half region on the real axis side of the first quadrant as the phase difference spectrum ϕ(k) in a case where Y(k) is in the first quadrant in the complex plane and |u(k)| is larger than |v(k)|, obtains the predetermined phase difference spectrum representative value of the half region on the imaginary axis side of the first quadrant as the phase difference spectrum ϕ(k) in a case where Y(k) is in the first quadrant in the complex plane and |u(k)| is smaller than |v(k)|, obtains the predetermined phase difference spectrum representative value of the half region on the real axis side of the second quadrant as the phase difference spectrum ϕ(k) in a case where Y(k) is in the second quadrant in the complex plane and |u(k)| is larger than |v(k)|, obtains the predetermined phase difference spectrum representative value of the half region on the imaginary axis side of the second quadrant as the phase difference spectrum ϕ(k) in a case where Y(k) is in the second quadrant in the complex plane and |u(k)| is smaller than |v(k)|, obtains the predetermined phase difference spectrum representative value of the half region on the real axis side of the third quadrant as the phase difference spectrum ϕ(k) in a case where Y(k) is in the third quadrant in the complex plane and |u(k)| is larger than |v(k)|, obtains the predetermined phase difference spectrum representative value of the half region on the imaginary axis side of the third quadrant as the phase difference spectrum ϕ(k) in a case where Y(k) is in the third quadrant in the complex plane and |u(k)| is smaller than |v(k)|, obtains the predetermined phase difference spectrum representative value of the half region on the real axis side of the fourth quadrant as the phase difference spectrum ϕ(k) in a case where Y(k) is in the fourth quadrant of the complex plane and |u(k)| is larger than |v(k)|, and obtains the predetermined phase difference spectrum representative value of the half region on the imaginary axis side of the fourth quadrant as the phase difference spectrum ϕ(k) in a case where Y(k) is in fourth quadrant in the complex plane and |u(k)| is smaller than |v(k)|. Note that the phase difference spectrum estimation unit 122 may determine in which quadrant of the complex plane Y(k) is located, similarly to the phase difference spectrum estimation unit 122 of the first example. That is, the phase difference spectrum estimation unit 122 may determine in which quadrant of the complex plane Y(k) is located on the basis of whether the sign of u(k) or u(k) is a positive value or a negative value and whether the sign of the imaginary part v(k) or the imaginary part v(k) is a positive value or a negative value, for example, on the basis of a combination of the sign of u(k) and the sign of v(k) or a combination of whether u(k) and v(k) are a positive value and a negative value.

Note that, in a case where one bit at a predetermined position of each of bit strings of u(k) and v(k) expressed by a predetermined number of bits is a bit representing whether the bit is a positive value or a negative value, and a plurality of bits at other positions of the bit string represents an absolute value, the phase difference spectrum estimation unit 122 can obtain the absolute value |u(k)| of u(k) and the absolute value |v(k)| of v(k) by extracting a plurality of bits representing the absolute values of u(k) and v(k) or replacing a bit value representing a negative value with a bit value representing a positive value in a case where at least one of u(k) or v(k) is a negative value.

Note that, in the case where Y(k) is on the boundary line of the quadrants in the complex plane, the phase difference spectrum estimation unit 122 may perform step S122-B, assuming that Y(k) is in one of the quadrants sandwiching the boundary line, similarly to the phase difference spectrum estimation unit 122 of the first example. That is, in the case where Y(k) is on the boundary line of the quadrants in the complex plane, the phase difference spectrum estimation unit 122 may obtain the predetermined phase difference spectrum representative value on the boundary side of any one of the quadrants sandwiching the boundary line as the phase difference spectrum ϕ(k). Of which one of the quadrants sandwiching the boundary line the predetermined phase difference spectrum representative value on the boundary side is set as the phase difference spectrum ϕ(k) in the case where the Y(k) is on the boundary line of the quadrants in the complex plane may be predetermined and stored in the phase difference spectrum estimation unit 122. Specifically, in the case where Y(k) is on the boundary line between the first quadrant and the second quadrant, that is, in the case where u(k) is 0 and v(k) is a positive value, the phase difference spectrum estimation unit 122 may obtain any one of the predetermined phase difference spectrum representative value of the half region on the imaginary axis side of the first quadrant and the predetermined phase difference spectrum representative value of the half region on the imaginary axis side of the second quadrant as the phase difference spectrum ϕ(k). Similarly, in the case where Y(k) is on the boundary line between the second quadrant and the third quadrant, that is, in the case where u(k) is a negative value and v(k) is 0, the phase difference spectrum estimation unit 122 may obtain any one of the predetermined phase difference spectrum representative value of the half region on the real axis side of the second quadrant and the predetermined phase difference spectrum representative value of the half region on the real axis side of the third quadrant as the phase difference spectrum ϕ(k). Similarly, in the case where Y(k) is on the boundary line between the third quadrant and the fourth quadrant, that is, in the case where u(k) is 0 and v(k) is a negative value, the phase difference spectrum estimation unit 122 may obtain any one of the predetermined phase difference spectrum representative value of the half region on the imaginary axis side of the third quadrant and the predetermined phase difference spectrum representative value of the half region on the imaginary axis side of the fourth quadrant as the phase difference spectrum ϕ(k). Similarly, in the case where Y(k) is on the boundary line between the fourth quadrant and the first quadrant, that is, in the case where u(k) is a positive value and v(k) is 0, the phase difference spectrum estimation unit 122 may obtain any one of the predetermined phase difference spectrum representative value of the half region on the real axis side of the fourth quadrant and the predetermined phase difference spectrum representative value of the half region on the real axis side of the first quadrant as the phase difference spectrum ϕ(k).

Further, in a case where Y(k) is on the boundary line between the half region on the real axis side and the half region on the imaginary axis side of a certain quadrant, the phase difference spectrum estimation unit 122 may perform step S122-B, assuming that Y(k) is in one of the regions sandwiching the boundary line of the quadrant. In a case of making determination using |u(k)| and |v(k)|, and in the case where |u(k)| and |v(k)| are the same value, the phase difference spectrum estimation unit 122 may obtain the predetermined phase difference spectrum representative value of the half region on the real axis side as the phase difference spectrum ϕ(k) similarly to the case where |u(k)| is larger than |v(k)|, or obtain the predetermined phase difference spectrum representative value of the half region on the imaginary axis side as the phase difference spectrum ϕ(k) similarly to the case where |u(k)| is smaller than |v(k)|. That is, the phase difference spectrum estimation unit 122 may perform step S122-B by replacing “the case where |u(k)| is larger than |v(k)|” with “the case where |u(k)| is equal to or larger than |v(k)|”, or may perform step S122-B by replacing “the case where |u(k)| is smaller than |v(k)|” with “the case where |u(k)| is equal to or smaller than |v(k)|”. Which replacement is performed may be determined in advance and stored in the phase difference spectrum estimation unit 122.

Specifically, in a case where Y(k) is in the first quadrant of the complex plane and |u(k)| and |v(k)| are the same value, the phase difference spectrum estimation unit 122 may obtain any one of the predetermined phase difference spectrum representative value of the half region on the real axis side of the first quadrant and the predetermined phase difference spectrum representative value of the half region on the imaginary axis side of the first quadrant as the phase difference spectrum ϕ(k). Similarly, in a case where Y(k) is in the second quadrant of the complex plane and |u(k)| and |v(k)| are the same value, the phase difference spectrum estimation unit 122 may obtain any one of the predetermined phase difference spectrum representative value of the half region on the real axis side of the second quadrant and the predetermined phase difference spectrum representative value of the half region on the imaginary axis side of the second quadrant as the phase difference spectrum ϕ(k). Similarly, in a case where Y(k) is in the third quadrant of the complex plane and |u(k)| and |v(k)| are the same value, the phase difference spectrum estimation unit 122 may obtain any one of the predetermined phase difference spectrum representative value of the half region on the real axis side of the third quadrant and the predetermined phase difference spectrum representative value of the half region on the imaginary axis side of the third quadrant as the phase difference spectrum ϕ(k). Similarly, in a case where Y(k) is in the fourth quadrant of the complex plane and |u(k)| and |v(k)| are the same value, the phase difference spectrum estimation unit 122 may obtain any one of the predetermined phase difference spectrum representative value of the half region on the real axis side of the fourth quadrant and the predetermined phase difference spectrum representative value of the half region on the imaginary axis side of the fourth quadrant as the phase difference spectrum ϕ(k).

### [[Modification of Second Example of Phase Difference Spectrum Estimation Unit 122]]

In addition to step S122-B, in the case where Y(k) is on the boundary line of the quadrants in the complex plane, the phase difference spectrum estimation unit 122 may obtain the predetermined phase difference spectrum representative value in the case where Y(k) is on the boundary line of the quadrants as the phase difference spectrum ϕ(k) (step S122-B2), similarly to the phase difference spectrum estimation unit 122 of the modification of the first example.

In addition to step S122-B or in addition to steps S122-B and S122-B2, in a case where Y(k) is on the boundary line between the half region on the real axis side and the half region on the imaginary axis side of a certain quadrant, the phase difference spectrum estimation unit 122 may obtain a predetermined phase difference spectrum representative value in the case where Y(k) is on the boundary line between the half region on the real axis side and the half region on the imaginary axis side of the quadrant as the phase difference spectrum ϕ(k) (step S122-B3). That is, in the case of making determination using |u(k)| and |v(k)|, and in the case where |u(k)| and |v(k)| are the same value, the phase difference spectrum estimation unit 122 may obtain the predetermined phase difference spectrum representative value in the case where |u(k)| and |v(k)| are the same value as the phase difference spectrum ϕ(k).

Specifically, in the case where Y(k) is in the first quadrant of the complex plane and |u(k)| and |v(k)| are the same value, the phase difference spectrum estimation unit 122 may obtain the predetermined phase difference spectrum representative value in the case where Y(k) is in the first quadrant of the complex plane and |u(k)| and |v(k)| are the same value as the phase difference spectrum ϕ(k). Similarly, in the case where Y(k) is in the second quadrant of the complex plane and |u(k)| and |v(k)| are the same value, the phase difference spectrum estimation unit 122 may obtain the predetermined phase difference spectrum representative value in the case where Y(k) is in the second quadrant of the complex plane and |u(k)| and |v(k)| are the same value as the phase difference spectrum ϕ(k). Similarly, in the case where Y(k) is in the third quadrant of the complex plane and |u(k)| and |v(k)| are the same value, the phase difference spectrum estimation unit 122 may obtain the predetermined phase difference spectrum representative value in the case where Y(k) is in the third quadrant of the complex plane and |u(k)| and |v(k)| are the same value as the phase difference spectrum ϕ(k). Similarly, in the case where Y(k) is in the fourth quadrant of the complex plane and |u(k)| and |v(k)| are the same value, the phase difference spectrum estimation unit 122 may obtain the predetermined phase difference spectrum representative value in the case where Y(k) is in the fourth quadrant of the complex plane and |u(k)| and |v(k)| are the same value as the phase difference spectrum ϕ(k).

The predetermined phase difference spectrum representative value in the case where the phase difference spectrum is on the boundary line between the half region on the real axis side and the half region on the imaginary axis side for each quadrant, that is, the predetermined phase difference spectrum representative value in the case where |u(k)| and |v(k)| for each quadrant are the same value, is stored in the representative value storage unit 1221 in the phase difference spectrum estimation unit 122. The phase difference spectrum representative value in the case where Y(k) is on the boundary line between the half region on the real axis side and the half region on the imaginary axis side of the first quadrant, that is, the phase difference spectrum representative value in the case where Y(k) is in the first quadrant of the complex plane and |u(k)| and |v(k)| are the same value is, for example, a value of a point on the circumference of the unit circle of which the argument on the complex plane is π/4, specifically, a value with the real part of cos(π/4) and the imaginary part of sin(π/4). The phase difference spectrum representative value in the case where Y(k) is on the boundary line between the half region on the real axis side and the half region on the imaginary axis side of the second quadrant, that is, the phase difference spectrum representative value in the case where Y(k) is in the second quadrant of the complex plane and |u(k)| and |v(k)| are the same value is, for example, a value of a point on the circumference of the unit circle of which the argument on the complex plane is 3π/4, specifically, a value with the real part of cos(3π/4) and the imaginary part of sin(3π/4). The phase difference spectrum representative value in the case where Y(k) is on the boundary line between the half region on the real axis side and the half region on the imaginary axis side of the third quadrant, that is, the phase difference spectrum representative value in the case where Y(k) is in the third quadrant of the complex plane and |u(k)| and |v(k)| are the same value is, for example, a value of a point on the circumference of the unit circle of which the argument on the complex plane is 5π/4, specifically, a value with the real part of cos(5π/4) and the imaginary part of sin(5π/4). The phase difference spectrum representative value in the case where Y(k) is on the boundary line between the half region on the real axis side and the half region on the imaginary axis side of the fourth quadrant, that is, the phase difference spectrum representative value in the case where Y(k) is in the fourth quadrant of the complex plane and |u(k)| and |v(k)| are the same value is, for example, a value of a point on the circumference of the unit circle of which the argument on the complex plane is 7π/4, specifically, a value with the real part of cos(7π/4) and the imaginary part of sin(7π/4).

### [[Third Example of Phase Difference Spectrum Estimation Unit 122]]

The argument of the phase difference spectrum estimated by the phase difference spectrum estimation unit 122 of the second example has an error of π/8 at the maximum. In the second example, each quadrant is divided into two regions of the half region on the real axis side and the half region on the imaginary axis side, and the argument range of the region of Y(k) corresponding to each representative value of the phase difference spectrum is π/4. However, to reduce the estimated error in the argument of the phase difference spectrum, each quadrant may be divided into three or more regions, and the argument range of the region of Y(k) corresponding to each representative value of the phase difference spectrum may be further narrowed. In a case where N is 3 or more, where an integer of 2 or more is the number of divisions of each quadrant, the phase difference spectrum estimation unit 122 of the third example enables estimation of the phase difference spectrum ϕ(k) with less error than the phase difference spectrum estimation unit 122 of the second example. Hereinafter description will be given assuming that π is each integer of 1 or more and 4N or less.

In a case where the argument θ of Y(k) is larger than (n−1)π/2N and smaller than nπ/2N (that is, (n−1)π/2N <θ<nπ/2N is satisfied), the phase difference spectrum estimation unit 122 of the third example obtains a predetermined phase difference spectrum representative value in the case where (n−1)π/2N <θ<nπ/2N as the phase difference spectrum ϕ(k) (step S122-C). Each representative value of the phase difference spectrum is predetermined and stored in the representative value storage unit 1221 in the phase difference spectrum estimation unit 122. The phase difference spectrum representative value in the case where (n−1)π/2N <θ<nπ/2N is, for example, a value of a point on the circumference of the unit circle of which the argument on the complex plane is (2n−1)π/4N, specifically, a value with the real part of cos((2n−1)π/4N) and the imaginary part of sin((2n−1)π/4N). The argument (2n−1)π/4N on the complex plane is a median of the argument range from (n −1)π/2N to nπ/2N on the complex plane.

In the first quadrant, in a case where the argument θ of Y(k) is larger than (n−1)π/2N, the absolute value |v(k)| of the imaginary part of Y(k) is larger than the product of the absolute value |u(k)| of the real part of Y(k) and tan((n−1)π/2N), and in a case where the argument θ of Y(k) is smaller than nπ/2N, the absolute value |v(k)| of the imaginary part of Y(k) is smaller than the product of the absolute value |u(k)| of the real part of Y(k) and tan(nπ/2N). Therefore, in the case where Y(k) is in the first quadrant, and |v(k)| is larger than the product of |u(k)| and tan((n−1)π/2N) and |v(k)| is smaller than the product of |u(k)| and tan(nπ/2N) (that is, Y(k) is in the first quadrant, and |u(k)|×tan((n−1)π/2N)<|v(k)|<|u(k)|×tan(nπ/2N) is satisfied), the phase difference spectrum estimation unit 122 may obtain the value with the real part of cos(((2n−1)π/4N) and the imaginary part of sin((2n−1)π/4N) as the phase difference spectrum ϕ(k). Note that, as a matter of course, |u(k)| may be compared with |v(k)| multiplied by a reciprocal of the value of tangent, using the reciprocal of the value of tangent, instead of comparing |u(k)| multiplied by the value of tangent with |v(k)|. The same similarly applies to the subsequent comparison.

In the second quadrant, in the case where the argument θ of Y(k) is larger than (n−1)π/2N, the absolute value |v(k)| of the imaginary part of Y(k) is smaller than the product of the absolute value |u(k)| of the real part of Y(k) and |tan((n−1)π/2N)|, and in the case where the argument θ of Y(k) is smaller than nπ/2N, the absolute value |v(k)| of the imaginary part of Y(k) is larger than the product of the absolute value |u(k)| of the real part of Y(k) and |tan(nπ/2N)|. Therefore, in the case where Y(k) is in the second quadrant, and |v(k)| is smaller than the product of |u(k)| and |tan((n−1)π/2N)| and |v(k)| is larger than the product of |u(k)| and |tan(nπ/2N)| (that is, Y(k) is in the second quadrant, and |u(k)|×|tan((n−1)π/2N)|>|v(k)|>|u(k)|×|tan(nπ/2N)| is satisfied), the phase difference spectrum estimation unit 122 may obtain the value with the real part of cos(((2n−1)π/4N) and the imaginary part of sin((2n−1)π/4N) as the phase difference spectrum ϕ(k). Note that, as a matter of course, |u(k)| may be compared with |v(k)| multiplied by the absolute value of the reciprocal of the value of tangent, using the absolute value of the reciprocal of the value of tangent, instead of comparing |u(k)| multiplied by the absolute value of tangent with |v(k)|. The same similarly applies to the subsequent comparison.

In the third quadrant, in the case where the argument θ of Y(k) is larger than (n−1)π/2N, the absolute value |v(k)| of the imaginary part of Y(k) is larger than the product of the absolute value |u(k)| of the real part of Y(k) and |tan((n−1)π/2N)|, and in the case where the argument θ of Y(k) is smaller than nπ/2N, the absolute value |v(k)| of the imaginary part of Y(k) is smaller than the product of the absolute value |u(k)| of the real part of Y(k) and |tan(nπ/2N)|. Therefore, in the case where Y(k) is in the third quadrant, and |v(k)| is larger than the product of |u(k)| and |tan((n−1)π/2N)| and |v(k)| is smaller than the product of |u(k)| and |tan(nπ/2N)| (that is, Y(k) is in the third quadrant, and |u(k)|×|tan((n−1)π/2N)|<|v(k)|<|u(k)|×|tan(nπ/2N)| is satisfied), the phase difference spectrum estimation unit 122 may obtain the value with the real part of cos(((2n−1)π/4N) and the imaginary part of sin((2n−1)π/4N) as the phase difference spectrum ϕ(k).

In the fourth quadrant, in the case where the argument θ of Y(k) is larger than (n−1)π/2N, the absolute value |v(k)| of the imaginary part of Y(k) is smaller than the product of the absolute value |u(k)| of the real part of Y(k) and |tan((n−1)π/2N)|, and in the case where the argument θ of Y(k) is smaller than nπ/2N, the absolute value |v(k)| of the imaginary part of Y(k) is larger than the product of the absolute value |u(k)| of the real part of Y(k) and |tan(nπ/2N)|. Therefore, in the case where Y(k) is in the fourth quadrant, and |v(k)| is smaller than the product of |u(k)| and |tan((n−1)π/2N)| and |v(k)| is larger than the product of |u(k)| and |tan(nπ/2N)| (that is, Y(k) is in the fourth quadrant, and |u(k)|×|tan((n−1)π/2N)|>|v(k)|>|u(k)|×|tan(nπ/2N)| is satisfied), the phase difference spectrum estimation unit 122 may obtain the value with the real part of cos(((2n−1)π/4N) and the imaginary part of sin((2n−1)π/4N) as the phase difference spectrum ϕ(k).

The phase difference spectrum estimation unit 122 may determine in which quadrant of the complex plane Y(k) is located, similarly to the phase difference spectrum estimation unit 122 of the first example. That is, the phase difference spectrum estimation unit 122 may determine in which quadrant of the complex plane Y(k) is located on the basis of whether the sign of u(k) or u(k) is a positive value or a negative value and whether the sign of the imaginary part v(k) or the imaginary part v(k) is a positive value or a negative value, for example, on the basis of a combination of the sign of u(k) and the sign of v(k) or a combination of whether u(k) and v(k) are a positive value and a negative value.

In the case where Y(k) is on the boundary line of the region, the phase difference spectrum estimation unit 122 may perform step S122-C, assuming that Y(k) is in one of the regions sandwiching the boundary line. That is, the phase difference spectrum estimation unit 122 may obtain a predetermined phase difference spectrum representative value in a case of (n−1)π/2N <θ≤nπ/2N, in a case where the argument θ of Y(k) is larger than (n−1)π/2N and equal to or smaller than nπ/2N (that is, (n−1)π/2N <θ≤nπ/2N is satisfied) as the phase difference spectrum ϕ(k), or may obtain a predetermined phase difference spectrum representative value in a case of (n−1)π/2N ≤θ<nπ/2N, in a case where the argument θ of Y(k) is equal to or larger than (n−1)π/2N and smaller than nπ/2N (that is, (n −1)π/2N≤θ<nπ/2N is satisfied) as the phase difference spectrum ϕ(k).

Specifically, the phase difference spectrum estimation unit 122 may obtain the value with the real part of cos((2n−1)π/4N) and the imaginary part of sin((2n−1)π/4N) as the phase difference spectrum ϕ(k) in a case where Y(k) is in the first quadrant or on the boundary line between the first quadrant and the second quadrant and |u(k)|×tan((n−1)π/2N)<|v(k)≤|u(k)|×tan(nπ/2N) is satisfied, obtain the value with the real part of cos((2n−1)π/4N) and the imaginary part of sin((2n−1)π/4N) as the phase difference spectrum ϕ(k) in a case where Y(k) is in the second quadrant or on the boundary line between the second quadrant and the third quadrant and |u(k)|×|tan((n −1)π/2N)|>|v(k)|≥|u(k)|×|tan(nπ/2N)| is satisfied, obtain the value with the real part of cos((2n−1)π/4N) and the imaginary part of sin((2n−1)π/4N) as the phase difference spectrum ϕ(k) in a case where Y(k) is in the third quadrant or on the boundary line between the third quadrant and the fourth quadrant and |u(k)|×|tan((n−1)π/2N)|<v(k) |u(k)|×|tan(nπ/2N)| is satisfied, and obtain the value with the real part of cos((2n−1)π/4N) and the imaginary part of sin((2n−1)π/4N) as the phase difference spectrum ϕ(k) in a case where Y(k) is in the fourth quadrant or on the boundary line between the fourth quadrant and the first quadrant and |u(k)|×|tan((n−1)π/2N)|>|v(k)|≥|u(k)|×|tan(nπ/2N)| is satisfied.

Alternatively, the phase difference spectrum estimation unit 122 may obtain the value with the real part of cos((2n−1)π/4N) and the imaginary part of sin((2n−1)π/4N) as the phase difference spectrum ϕ(k) in a case where Y(k) is in the first quadrant or on the boundary line between the fourth quadrant and the first quadrant and |u(k)|×tan((n−1)π/2N)≤|v(k)|<|u(k)|×tan(nπ/2N) is satisfied, obtain the value with the real part of cos((2n−1)π/4N) and the imaginary part of sin((2n−1)π/4N) as the phase difference spectrum ϕ(k) in a case where Y(k) is in the second quadrant or on the boundary line between the first quadrant and the second quadrant and |u(k)|×|tan((n −1)π/2N)|≥|v(k)|>|u(k)|×|tan(nπ/2N)| is satisfied, obtain the value with the real part of cos((2n−1)π/4N) and the imaginary part of sin((2n−1)π/4N) as the phase difference spectrum ϕ(k) in a case where Y(k) is in the third quadrant or on the boundary line between the second quadrant and the third quadrant and |u(k)|×|tan((n−1)π/2N)≤|v(k)|<|u(k)|×|tan(nπ/2N)| is satisfied, and obtain the value with the real part of cos((2n−1)π/4N) and the imaginary part of sin((2n−1)π/4N) as the phase difference spectrum ϕ(k) in a case where Y(k) is in the fourth quadrant or on the boundary line between the third quadrant and the fourth quadrant and |u(k)|×|tan((n−1)π/2N)|≥|v(k)|>|u(k)|×|tan(nπ/2N)| is satisfied.

### [[Modification of Third Example of Phase Difference Spectrum Estimation Unit 122]]

In addition to step S122-C, in the case where Y(k) is on the boundary line of regions, the phase difference spectrum estimation unit 122 may obtain a predetermined phase difference spectrum representative value in the case where Y(k) is on the boundary line of the regions as the phase difference spectrum ϕ(k) (step S122-C2). That is, in a case where the argument θ of Y(k) is nπ/2N, the phase difference spectrum estimation unit 122 may obtain the predetermined phase difference spectrum representative value in the case where the argument θ of Y(k) is nπ/2N as the phase difference spectrum ϕ(k). Specifically, in a case of |u(k)|×tan(nπ/2N)=|v(k)|, the phase difference spectrum estimation unit 122 may obtain a value with the real part of cos(nπ/2N) and the imaginary part of sin(nπ/2N) as the phase difference spectrum ϕ(k).

### [[Fourth Example of Phase Difference Spectrum Estimation Unit 122]]

In the fourth example, an example of estimating the phase difference spectrum using a binary search in a quadrant will be described. Note that description including a case where a search in a quadrant is not performed will be given for convenience. Hereinafter, P is the number of times of performing the binary search, and is a predetermined integer of 0 or more. For example, the phase difference spectrum estimation unit 122 of the fourth example does not perform a search in a quadrant when P=0 (that is, the binary search is not performed even once), performs the binary search once when P=1, and performs the binary search twice when P=2. P may be an individual value for each frequency k, or may be the same value for all frequencies.

The phase difference spectrum estimation unit 122 of the fourth example searches for in which quadrant Y(k) exists, and obtains a predetermined phase difference spectrum representative value for the quadrant in which Y(k) exists as the phase difference spectrum ϕ(k) when P=0, and specifies the argument range in which Y(k) exists by performing the binary search for the argument range P times for the quadrant in which Y(k) exists, and obtains the predetermined phase difference spectrum representative value for the specified argument range as the phase difference spectrum ϕ(k) when P≠0 (step S122-D). Each representative value of the phase difference spectrum is predetermined and stored in the representative value storage unit 1221 in the phase difference spectrum estimation unit 122.

The phase difference spectrum representative value of each quadrant is, for example, a complex value of a point on the circumference of the unit circle where the argument of the complex plane is the median of the argument range of the quadrant. Specifically, the representative value is a value in which the real part is the cosine of the median of the argument range of the quadrant and the imaginary part is the sine of the median of the argument range of the quadrant. The phase difference spectrum representative value of each argument range is, for example, a complex value of a point on the circumference of the unit circle where the argument of the complex plane is the median of the range. Specifically, the representative value is a value in which the real part is the cosine of the median of the argument range and the imaginary part is the sine of the median of the argument range.

In each quadrant, there may be a deviation in a frequency distribution of the argument of the phase difference spectrum depending on a relationship between signals of two channels and a frequency. Therefore, the phase difference spectrum representative value may be set in consideration of the deviation in the frequency distribution of the argument. That is, it is not essential that the phase difference spectrum representative value of each quadrant is the complex value of a point on the circumference of the unit circle where the argument of the complex plane is a median of the argument range of the quadrant. The phase difference spectrum representative value of each quadrant may be a complex value of a predetermined point on the circumference of the unit circle where the argument of the complex plane is within the argument range of the quadrant. Specifically, the representative value may be a value in which the real part is a cosine of the argument representative value, of the argument range of the quadrant, and the imaginary part is a sine of the argument representative value, of the argument range of the quadrant. Similarly, it is not essential that the phase difference spectrum representative value in each argument range is the complex value of a point on the circumference of the unit circle where the argument of the complex plane is a median of the argument range of the quadrant. The phase difference spectrum representative value in each argument range may be a complex value of a predetermined point on the circumference of the unit circle of which the argument of the complex plane is within the argument range. Specifically, the representative value is a value in which the real part is a cosine of the argument representative value in the argument range and the imaginary part is a sine of the argument representative value in the argument range.

For example, in a case where digital sound signals obtained by performing AD conversion for sounds collected by a left-channel microphone and a right-channel microphone arranged in a certain space are a first channel input sound signal and a second channel input sound signal, and a voice uttered by a person present in the space is included in the first channel input sound signal and the second channel input sound signal in a state where a so-called arrival time difference is given, the phase difference spectrum is distributed unevenly at an argument close to the real axis side on the circumference of the unit circle of the complex plane at a low frequency, and is almost uniformly distributed without being unevenly at a specific argument on the circumference of the unit circle of the complex plane at middle and high frequencies. From the above fact, for example, the value of the argument of the complex plane, of the phase difference spectrum representative value of each quadrant, may be a value in which the argument of the complex plane is closer to the real axis than the median of the argument range of the quadrant in a case where the frequency is equal to or less than a predetermined threshold or is less than the threshold, or may be a value in which the argument of the complex plane is the median of the argument range of the quadrant in a case where the frequency is another frequency (that is, in a case where the frequency is higher than the threshold or is equal to or higher than the threshold). Alternatively, for example, the value of the argument of the complex plane, of the phase difference spectrum representative value of each quadrant, may be a value in which the argument of the complex plane is closer to the real axis than the median of the argument range of the quadrant as the frequency is lower, or may be a value in which the argument of the complex plane is closer to the median of the argument range of the quadrant than the real axis as the frequency is higher.

Similarly, for example, the value of the argument of the complex plane, of the phase difference spectrum representative value of each range, may be a value in which the argument of the complex plane is closer to the real axis than the median of the argument range in a case where the frequency is equal to or less than a predetermined threshold or is less than the threshold, or may be a value in which the argument of the complex plane is the median of the argument range in a case where the frequency is another frequency (that is, in a case where the frequency is higher than the threshold or is equal to or higher than the threshold). Alternatively, for example, the value of the argument of the complex plane, of the phase difference spectrum representative value of each argument range, may be a value in which the argument of the complex plane is closer to the real axis than the median of the argument range as the frequency is lower, or may be a value in which the argument of the complex plane is closer to the median of the argument range than the real axis as the frequency is higher.

The above-described threshold is favorably determined in advance such that, for example, being approximately equal to or less than 500 Hz or being approximately less than 500 Hz is being equal to or less than the threshold or being less than the threshold. Further, the above-described threshold may be determined for sample numbers (sample indexes) allocated in order from a low frequency side. Therefore, for example, when the frame length is 20 ms, even in a case where the sampling frequency is 32 kHz and the phase difference spectrum is obtained for substantially 320 frequencies, even in a case where the sampling frequency is 48 kHz and the phase difference spectrum is obtained for substantially 480 frequencies, even in a case where the sampling frequency is 16 kHz and the phase difference spectrum is obtained for substantially 160 frequencies, that is, regardless of the sampling frequency, in a case where the threshold is 10, and the index is equal to or less than the threshold of 10, the value of the argument of the complex plane of the phase difference spectrum representative value may be set to be a value closer to the real axis than the median of the argument range, and in a case where the index is larger than the threshold of 10, the value of the argument of the complex plane of the phase difference spectrum representative value may be set to be the median value of the argument range. Similarly, for example, when the frame length is 40 ms that is twice 20 ms, the threshold may be set to 20, and when the frame length is 10 ms that is ½ of 20 ms, the threshold may be set to 5.

Note that, in a specific example to be described below in step S122-D, since the absolute value of the tangent, the value of the cosine, and the value of the sine, of representative values of cases where the argument of the complex plane is the argument of each quadrant and in each range of argument are used, the absolute value of the tangent, the value of the cosine, and the value of the sine, of the argument representative values of the argument range of each quadrant and of each range of argument may be calculated in advance and stored in the representative value storage unit 1221. As a matter of course, the representative value storage unit 1221 may store, instead of the above-described cosine value and sine value, a complex value in which the real part is the cosine and the imaginary part is the sine. Further, in a case where the phase difference spectrum representative value of each quadrant is the median in a range where the argument of the complex plane is the argument of the quadrant, and the phase difference spectrum estimation unit 122 does not use the absolute value of the tangent of the representative value in the argument range of each quadrant, the absolute value of the tangent of the representative value in the argument range of each quadrant may not be stored in the representative value storage unit 1221.

A specific example of step S122-D performed by the phase difference spectrum estimation unit 122 will be described in steps S122-D1 to S122-D6 below.

The phase difference spectrum estimation unit 122 first sets p=0 and determines in which quadrant of the complex plane Y(k) is located, and obtains the argument representative value in the argument range of the quadrant in which Y(k) exists (step S122-D1). The phase difference spectrum estimation unit 122 may make a determination as to in which quadrant of the complex plane Y(k) is located in a similar manner to the phase difference spectrum estimation unit 122 of the first example. That is, the phase difference spectrum estimation unit 122 may determine in which quadrant of the complex plane Y(k) is located on the basis of whether the sign of u(k) or u(k) is a positive value or a negative value and whether the sign of the imaginary part v(k) or the imaginary part v(k) is a positive value or a negative value, for example, on the basis of a combination of the sign of u(k) and the sign of v(k) or a combination of whether u(k) and v(k) are a positive value and a negative value.

Next to step S122-D1, in a case of p=P (that is, in a case of P=0), the phase difference spectrum estimation unit 122 obtains, as the phase difference spectrum ϕ(k), a complex value of the point on the circumference of the unit circle of which the argument of the complex plane is the argument representative value obtained in step S122-D1, that is, a complex value in which the real part is the cosine of the argument representative value obtained in step S122-D1 and the imaginary part is the sine of the argument representative value obtained in step S122-D1, the value being a predetermined phase difference spectrum representative value (step S122-D2). In the case of P=0, the phase difference spectrum estimation unit 122 terminates the processing of step S122-D in step S122-D2. Note that, in the case where the phase difference spectrum estimation unit 122 terminates the processing of step S122-D in step S122-D2, the phase difference spectrum estimation unit 122 obtains a result similar to the phase difference spectrum estimation unit 122 of the first example.

Next to step S122-D1, in a case of not p=P (in a case of p≠P), the phase difference spectrum estimation unit 122 sets a value obtained by adding 1 to p as new p (that is, 1 is set as new p), and obtains the argument range of the quadrant in which Y(k) exists as a search range of the next step and obtains the absolute value of the tangent of the representative value (that is, the argument representative value of the search range in the next step) of the argument obtained in step S122-D1 (step S122-D3).

Next to step S122-D3 or step S122-D6 to be described below, the phase difference spectrum estimation unit 122 determines that Y(k) exists in the range on the real axis side in the search range, and obtains the argument representative value of the range on the real axis side in the search range, in a case where a value obtained by multiplying |u(k)| by the absolute value of the tangent of the argument representative value of the search range obtained in the immediately preceding processing (that is, step S122-D3 or step S122-D6 to be described below) is larger than |v(k)|, and determines that Y(k) exists in the range on the imaginary axis side in the search range, and obtains the argument representative value of the range on the imaginary axis side in the search range, in a case where the value obtained by multiplying |u(k)| by the absolute value of the tangent of the argument representative value of the search range obtained in the immediately preceding processing is smaller than |v(k)| (step S122-D4).

As a matter of course, comparing a value obtained by multiplying |v(k)| by the absolute value of the cotangent of the argument representative value of the search range with |u(k)| may be performed instead of comparing a value obtained by multiplying |u(k)| by the absolute value of the tangent of the argument representative value of the search range with |v(k)|. That is, next to step S122-D3 or step S122-D6 to be described below, the phase difference spectrum estimation unit 122 may determine that Y(k) exists in the range on the real axis side in the search range, and obtains the argument representative value of the range on the real axis side in the search range, in a case where |u(k)| is larger than a value obtained by multiplying |v(k)| by the absolute value of the cotangent of the argument representative value of the search range obtained in the immediately preceding processing, and determine that Y(k) exists in the range on the imaginary axis side in the search range, and obtains the argument representative value of the range on the imaginary axis side in the search range, in a case where |u(k)| is smaller the value obtained by multiplying |v(k)| by the absolute value of the cotangent of the argument representative value of the search range obtained in the immediately preceding processing. In this case, since the absolute value of the cotangent of the case where the argument of the complex plane is the argument representative value range is used, the absolute value of the cotangent of the representative value of each argument range may be calculated in advance and be stored in the representative value storage unit 1221. The phase difference spectrum estimation unit 122 may obtain the absolute value of the cotangent of the argument representative value of the search range in the next step, instead of the absolute value of the tangent of the argument representative value of the search range in the next step in step S122-D3 as the immediately preceding step or step S122-D6 to be described below.

Note that the range on the real axis side in the search range is a range on the real axis side in the search range when the search range in the complex plane is divided into two parts by a straight line whose argument is the representative value, and the range on the imaginary axis side in the search range is a range on the imaginary axis side in the search range when the search range in the complex plane is divided into two parts by the straight line whose argument is the representative value. In the case where the argument representative value of the search range is the median of the argument of the search range, the range on the real axis side in the search range is a half range on the real axis side in the search range when the search range in the complex plane is divided into two equal parts by a straight line whose argument is the median, and the range on the imaginary axis side in the search range is a half range on the imaginary axis side in the search range when the search range in the complex plane is divided into two equal parts by the straight line whose argument is the median.

Note that, in a case where the processing immediately before step S122-D4 is step S122-D3 and the argument representative value obtained in step S122-D1 is the median of the argument, the absolute value of the tangent of the representative value in the search range obtained in the immediately preceding processing is always 1. Therefore, the phase difference spectrum estimation unit 122 may perform processing in “a case where |u(k)| is larger than |v(k)|” instead of “the case where a value obtained by multiplying |u(k)| by the absolute value of the tangent of the argument representative value of the search range is larger than |v(k)|”, may perform processing in “a case where |u(k)| is smaller than |v(k)|” instead of “the case where the value obtained by multiplying |u(k)| by the absolute value of the tangent of the argument representative value of the search range is smaller than |v(k)|”, or may not obtain the absolute value of the tangent of the argument representative value in the argument range of the quadrant where Y(k) exists in step S122-D3 that is the immediately preceding processing. That is, in a case of being performed next to step S122-D3 of when the argument representative value obtained in step S122-D1 is the median, in the case where |u(k)| is larger than |v(k)|, the phase difference spectrum estimation unit 122 may determine that Y(k) exists in the half range on the real axis side of the search range obtained in step S122-D3, and obtain the argument representative value in the half range on the real axis side of the search range obtained in step S122-D3, and in the case where |u(k)| is smaller than |v(k)|, the phase difference spectrum estimation unit 122 may determine that Y(k) exists in the half range on the imaginary axis side of the search range obtained in step S122-D3, and obtain the argument representative value in the half range on the imaginary axis side of the search range obtained in step S122-D3; and in a case of being performed next to step S122-D6, in a case where the value obtained by multiplying |u(k)| by the absolute value of the tangent of the argument representative value of the search range obtained in step S122-D6 is larger than |v(k)|, the phase difference spectrum estimation unit 122 may determine that Y(k) exists in the range on the real axis side in the search range obtained in step S122-D6, and obtain the argument representative value of the range on the real axis side in the search range obtained in step S122-D6, and in a case where the value obtained by multiplying |u(k)| by the absolute value of the tangent of the argument representative value of the search range obtained in step S122-D6 is smaller than |v(k)|, the phase difference spectrum estimation unit 122 may determine that Y(k) exists in the range on the imaginary axis side in the search range obtained in step S122-D6, and obtain the argument representative value of the range on the imaginary axis side in the search range obtained in step S122-D6 as step S122-D4.

Next to step S122-D4, in the case of p=P, the phase difference spectrum estimation unit 122 obtains, as the phase difference spectrum ϕ(k), a complex value of the point on the circumference of the unit circle of which the argument of the complex plane is the argument representative value obtained in step S122-D4, that is, a complex value in which the real part is the cosine of the argument representative value obtained in step S122-D4 and the imaginary part is the sine of the argument representative value obtained in step S122-D4, the value being a predetermined representative value (step S122-D5). In the case of p=P, the phase difference spectrum estimation unit 122 terminates the processing of step S122-D in step S122-D5.

Next to step S122-D4, in a case of not p=P (in a case of p≠P), the phase difference spectrum estimation unit 122 sets a value obtained by adding 1 to p as new p, and obtains the argument range of the range in which Y(k) exists, which has been determined in step S122-D4, as a search range of the next step and obtains the absolute value of the tangent of the representative value (that is, the argument representative value of the search range in the next step) of the argument obtained in step S122-D4 (step S122-D6). Next to step S122-D6, the phase difference spectrum estimation unit 122 performs step S122-D4.

Note that, in step S122-D1, in the case where Y(k) is on the boundary line of the quadrants in the complex plane, the phase difference spectrum estimation unit 122 may perform the processing, assuming that Y(k) is in one of the quadrants sandwiching the boundary line, similarly to the phase difference spectrum estimation unit 122 of the first and second examples. Similarly, in a case where Y(k) is on the boundary line of two parts in the binary search of the argument range, the phase difference spectrum estimation unit 122 may perform the processing assuming that Y(k) is in one of the ranges sandwiching the boundary line. Specifically, in steps S122-D4, the phase difference spectrum estimation unit 122 may perform processing in “a case where the value obtained by multiplying |u(k)| by the absolute value of the tangent of the argument representative value of the search range is equal to or larger than |v(k)|” instead of “the case where the value obtained by multiplying |u(k)| by the absolute value of the tangent of the argument representative value of the search range is larger than |v(k)|”, or may perform processing in “a case where the value obtained by multiplying |u(k)| by the absolute value of the tangent of the argument representative value of the search range is equal to or less than |v(k)|” instead of “the case where the value obtained by multiplying |u(k)| by the absolute value of the tangent of the argument representative value of the search range is smaller than |v(k)|”. Similarly, in steps S122-D4, in a case of using cotangent, the phase difference spectrum estimation unit 122 may perform processing in “a case where |u(k)| is equal to or larger than the value obtained by multiplying |v(k)| by the absolute value of the cotangent of the argument representative value of the search range” instead of “the case where |u(k)| is larger than the value obtained by multiplying |v(k)| by the absolute value of the cotangent of the argument representative value of the search range”, or may perform processing in “a case where |u(k)| is equal to or smaller than the value obtained by multiplying |v(k)| by the absolute value of the cotangent of the argument representative value of the search range” instead of “the case where |u(k)| is smaller than the value obtained by multiplying |v(k)| by the absolute value of the cotangent of the argument representative value of the search range”.

### [[Modification of Fourth Example of Phase Difference Spectrum Estimation Unit 122]]

In the case where Y(k) is on the boundary line of the quadrants in the complex plane, the phase difference spectrum estimation unit 122 may obtain the predetermined phase difference spectrum representative value in the case where Y(k) is on the boundary line of the quadrants as the phase difference spectrum ϕ(k), similarly to the phase difference spectrum estimation unit 122 of the modification of the first example. Specifically, in step S122-D1, the phase difference spectrum estimation unit 122 determines whether Y(k) is on the boundary line of the quadrants in the complex plane, and in the case where Y(k) is on the boundary line of the quadrants in the complex plane, the phase difference spectrum estimation unit 122 may obtain the predetermined phase difference spectrum representative value in the case where Y(k) is on the boundary line of the quadrants as the phase difference spectrum ϕ(k), similarly to the phase difference spectrum estimation unit 122 of the modification of the first example, and terminate step S122-D.

Similarly, in the case where Y(k) is on the boundary line of two parts in the binary search of the argument range, the phase difference spectrum estimation unit 122 may obtain the predetermined phase difference spectrum representative value in the case where Y(k) is on the boundary line as the phase difference spectrum ϕ(k). Specifically, in step S122-D4, the phase difference spectrum estimation unit 122 may also determine whether the value obtained by multiplying |u(k)| by the absolute value of the tangent of the argument representative value of the search range obtained in the immediately preceding processing is the same as |v(k)|, and in a case where the value obtained by multiplying |u(k)| by the absolute value of the tangent of the argument representative value of the search range obtained in the immediately preceding processing is the same as |v(k)|, the phase difference spectrum estimation unit 122 may obtain a complex value in which the real part is the cosine of the argument representative value of the search range obtained in the immediately preceding processing and the imaginary part is the sine of the argument representative value of the search range obtained in the immediately preceding processing as the phase difference spectrum ϕ(k), and terminate step S122-D. As a matter of course, in step S122-D4, the phase difference spectrum estimation unit 122 also determines whether |u(k)| is the same as the value obtained by multiplying |v(k)| by the absolute value of the cotangent of the argument representative value of the search range obtained in the immediately preceding processing, instead of determining whether the value obtained by multiplying |u(k)| by the absolute value of the tangent of the argument representative value of the search range obtained in the immediately preceding processing is the same as |v(k)|, and in the case where |u(k)| is the same as the value obtained by multiplying |v(k)| by the absolute value of the cotangent of the argument representative value of the search range obtained in the immediately preceding processing, the phase difference spectrum estimation unit 122 may obtain a complex value in which the real part is the cosine of the argument representative value of the search range obtained in the immediately preceding processing and the imaginary part is the sine of the argument representative value of the search range obtained in the immediately preceding processing as the phase difference spectrum ϕ(k), and terminate step S122-D.

### [[Fifth Example of Phase Difference Spectrum Estimation Unit 122]]

In the phase difference spectrum estimation units 122 of the first to fourth examples, the relationship between the value of the real part and the value of the imaginary part of the product representing the argument on the complex plane of the product of the frequency spectrum of the first channel and the complex conjugate of the frequency spectrum of the second channel is associated in advance with each of a plurality of representative values of the phase difference spectra, but the association may not be performed in advance. This example will be described as a fifth example. In the description of the fifth example, Q is a predetermined integer of 2 or more.

The representative value storage unit 1221 of the phase difference spectrum estimation unit 122 stores Q predetermined phase difference spectrum candidate values. The Q predetermined phase difference spectrum candidate value are values on the circumference of the unit circle of the complex plane, and are values having different arguments on the complex plane. The Q predetermined phase difference spectrum candidate value may be arranged at equal intervals on the circumference of the unit circle of the complex plane, or may be arranged at unequal intervals on the circumference of the unit circle of the complex plane while being more densely arranged in an argument range with high frequency on the circumference of the unit circle of the complex plane in consideration of a bias in a frequency distribution of the arguments of the phase difference spectra. In addition, similarly to the fourth example, the Q phase difference spectrum candidate values may be determined in advance for each frequency or each frequency range in consideration of a difference for each frequency in the bias of the frequency distribution of the arguments of the phase difference spectra. For example, in a case where the frequency is equal to or less than a predetermined threshold or less than the threshold, the Q phase difference spectrum candidate values are arranged on the circumference of the unit circle of the complex plane such that the interval becomes denser as the argument is closer to the real axis, and in a case where the frequency is not equal to or less than the predetermined threshold or not less than the threshold (that is, in a case where the frequency is higher than the threshold or equal to or higher than the threshold), the Q phase difference spectrum candidate values are arranged at equal intervals on the circumference of the unit circle of the complex plane. Alternatively, for example, the Q phase difference spectrum candidate values may be arranged such that the lower the frequency, the larger the bias of the argument from the equal interval to a direction close to the real axis on the circumference of the unit circle of the complex plane, and the higher the frequency, the smaller the bias of the argument from the equal interval to the direction close to the real axis on the circumference of the unit circle of the complex plane. Note that the threshold is similar to that in the fourth example.

For each frequency k, the phase difference spectrum estimation unit 122 selects the candidate value of the phase difference spectrum having the argument closest to the argument on the complex plane of the product Y(k) of the frequency spectrum X₁(k) of the first channel and the complex conjugate ⁻X₂(k) of the frequency spectrum X₂(k) of the second channel from the Q predetermined phase difference spectrum candidate values and obtains the selected candidate value as the phase difference spectrum ϕ(k) (step S122-E).

tan θ(ϕ(q))=ϕ(q)_{imag}/ϕ(q)ᵣₑₐₗ is satisfied where q is each integer of 1 or more and Q or less, the phase difference spectrum candidate value is ϕ(q), the real part of ϕ(q) is ϕ(q)ᵣₑₐₗ, the imaginary part of ϕ(q) is ϕ(q)_{imag}, and the argument of ϕ(q) on the complex plane is θ(ϕ(q)). Meanwhile, tan θ(Y(k))=v(k)/u(k) is satisfied where the argument of Y(k) on the complex plane is θ(Y(k)). Therefore, the phase difference spectrum estimation unit 122 may select tan θ(ϕ(q)) closest to tan θ(Y(k)) from among Q tangents from tan θ(ϕ(1)) to tan θ(ϕ(Q)) for each frequency k and obtain ϕ(q) corresponding to the selected tan θ(ϕ(q)) as the phase difference spectrum ϕ(k). Note that, to prevent generation of a large amount of arithmetic processing by division for calculating tan θ(Y(k))=v(k)/u(k), specifically, for example, the representative value storage unit 1221 of the phase difference spectrum estimation unit 122 stores tan θ(ϕ(q)) in advance in association with each phase difference spectrum candidate value ϕ(q), and the phase difference spectrum estimation unit 122 may obtain, for each frequency k, ϕ(q) corresponding to tan θ(ϕ(q)) with the smallest |u(k)×tan θ(ϕ(q))−|v(k)| as the phase difference spectrum ϕ(k). As a matter of course, the representative value storage unit 1221 of the phase difference spectrum estimation unit 122 may also store in advance cot θ(ϕ(q)) that is a reciprocal of tan θ(ϕ(q)) in association with each phase difference spectrum candidate value ϕ(q), and the phase difference spectrum estimation unit 122 may obtain ϕ(q) corresponding to cot θ(ϕ(q)) with the smallest |u(k)−v(k)×cot θ(ϕ(q))| as the phase difference spectrum ϕ(k) for each frequency k. The value of tan θ(ϕ(q)) or the value of cot θ(ϕ(q)) used for the above-described processing by the phase difference spectrum estimation unit 122 may also be stored in the representative value storage unit 1221.

Note that, in the fifth example, since association of the product of the frequency spectrum of the first channel and the complex conjugate of the frequency spectrum of the second channel with the argument on the complex plane or the like is not performed in advance as in the representative values of the first example to the fourth example, the value stored in the representative value storage unit 1221 is referred to as a phase difference spectrum candidate value. Note that since it is possible to resultantly specify, with each candidate value of the fifth example, a correspondence relationship between the product of the frequency spectrum of the first channel and the complex conjugate of the frequency spectrum of the second channel and the argument on the complex plane, there is no problem even if each candidate value is referred to as a representative value similarly to the representative values of the first example to the fourth example.

[Summary of Phase Difference Spectrum Estimation Unit 122 (step S122)]

In short, as described in the first to fifth examples and the modifications of the first to fourth examples, the phase difference spectrum estimation unit 122 obtains, for each frequency k, one of the plurality of predetermined phase difference spectrum candidate values as the phase difference spectrum ϕ(k) on the basis of the relationship between the value of the real part u(k) and the value of an imaginary part v(k) of the product Y(k) of the frequency spectrum X₁(k) of the first channel and the complex conjugate ⁻X₂(k) of the frequency spectrum X₂(k) of the second channel. Here, the plurality of predetermined phase difference spectrum candidate values are values on the circumference of the unit circle of the complex plane, and are values having different arguments on the complex plane. In the first to fourth examples and the modifications thereof, each phase difference spectrum candidate value is associated in advance with the argument range on the complex plane of the product of the frequency spectrum of the first channel and the complex conjugate of the frequency spectrum of the second channel. In the first to fourth examples and the modifications thereof, the plurality of predetermined phase difference spectrum candidate values and the argument ranges corresponding to the respective candidate values are stored in advance in the representative value storage unit 1221. In the first to third examples and the modifications thereof, the phase difference spectrum estimation unit 122 selects, for each frequency k, one candidate value with the argument on the complex plane included in the associated argument range on the complex plane of the product of the frequency spectrum of the first channel and the complex conjugate of the frequency spectrum of the second channel, of the plurality of predetermined phase difference spectrum candidate values, using the relationship between the value of the real part u(k) of Y(k) and the value of the imaginary part v(k) representing the argument of Y(k) on the complex plane, and obtains the selected candidate value as the phase difference spectrum ϕ(k). In addition, in the fourth example and the modification thereof, for each frequency k, the phase difference spectrum estimation unit 122 specifies the argument range in which Y(k) exists by performing the binary search of the argument range P times, for the quadrant in which Y(k) exists, using the relationship between the value of the real part u(k) and the value of the imaginary part v(k) of Y(k) representing the argument on the complex plane, and obtains the phase difference spectrum candidate value determined in advance for the specified argument range as the phase difference spectrum ϕ(k).

For example, a case where the predetermined phase difference spectrum candidate values are four representative values and each representative value of the phase difference spectrum is associated with any one of the first quadrant to the fourth quadrant that are the argument range on the complex plane of the product of the frequency spectrum of the first channel and the complex conjugate of the frequency spectrum of the second channel corresponds to the above-described first example. In the first example, the phase difference spectrum estimation unit 122 obtains, for each frequency k, the representative value of the corresponding quadrant among the four predetermined phase difference spectrum representative values as the phase difference spectrum ϕ(k), using the combination of whether u(k) is a positive value or a negative value and whether v(k) is a positive value or a negative value as the relationship between the value of the real part u(k) and the value of the imaginary part v(k) of Y(k) representing the argument of Y(k) on the complex plane.

For example, a case where the predetermined phase difference spectrum candidate values are eight representative values and each representative value of the phase difference spectrum is associated with any one of a total of eight ranges, parts which are smaller and larger in the argument of each quadrant, that are the argument range on the complex plane of the product of the frequency spectrum of the first channel and the complex conjugate of the frequency spectrum of the second channel corresponds to the above-described second example. In the second example, the phase difference spectrum estimation unit 122 obtains, for each frequency k, the representative value of the corresponding range among the eight predetermined phase difference spectrum representative values as the phase difference spectrum ϕ(k), using the combination of whether u(k) is a positive value or a negative value and whether v(k) is a positive value or a negative value, and which of the absolute value |u(k)| of u(k) and the absolute value |v(k)| of v(k) is larger, as the relationship between the value of the real part u(k) and the value of the imaginary part v(k) of Y(k) representing the argument of Y(k) on the complex plane.

For example, a case where the predetermined phase difference spectrum candidate values are 4N representative values and each representative value of the phase difference spectrum is associated with any one range of a total of 4N ranges, obtained by dividing the argument of each quadrant into N parts, that are the argument range on the complex plane of the product of the frequency spectrum of the first channel and the complex conjugate of the frequency spectrum of the second channel corresponds to the above-described third example. In the third example, the phase difference spectrum estimation unit 122 obtains, for each frequency k, the representative value of the corresponding range among 4N predetermined phase difference spectrum representative values as the phase difference spectrum ϕ(k), using the combination of whether u(k) is a positive value or a negative value and whether v(k) is a positive value or a negative value, and which of |u(k)| and |v(k)| is larger after multiplying one of |u(k)| or |v(k)| with a predetermined value, as the relationship between the value of the real part u(k) and the value of the imaginary part v(k) of Y(k) representing the argument of Y(k) on the complex plane.

For example, specifying the quadrant in which Y(k) exists and performing the binary search of the quadrant in which Y(k) exists for the argument range corresponds to the above-described fourth example. In the fourth example, the phase difference spectrum estimation unit 122 obtains, for each frequency k, the representative value of the corresponding range among the plurality of predetermined phase difference spectrum representative values as the phase difference spectrum ϕ(k) by specifying the quadrant in which Y(k) exists, using the combination of whether u(k) is a positive value or a negative value and whether v(k) is a positive value or a negative value, and performing the binary search, using which of |u(k)| and |v(k)| is larger after multiplying one of |u(k)| or |v(k)| with a predetermined value.

For example, a case where the argument range on the complex plane of the product of the frequency spectrum of the first channel and the complex conjugate of the frequency spectrum of the second channel is not associated in advance with each candidate value of the phase difference spectrum, and a likely candidate value is selected corresponds to the above-described fifth example. In the fifth example, the candidate values ϕ(q) and tan θ(ϕ(q)) of each phase difference spectrum are stored in advance in the representative value storage unit 1221 of the phase difference spectrum estimation unit 122 for each integer q of 1 or more and Q or less, and the phase difference spectrum estimation unit 122 obtains ϕ(q) corresponding to tan θ(ϕ(q)) with the smallest |u(k)×tan θ(ϕ(q))−|v(k)| as the phase difference spectrum ϕ(k) for each frequency k.

The phase difference spectrum ϕ(k) of each frequency k from 0 to T−1 obtained by the phase difference spectrum estimation unit 122 is output from the phase difference spectrum estimation unit 122 and input to the inter-channel relationship information acquisition unit 123.

### [Inter-channel Relationship Information Acquisition Unit 123]

The inter-channel relationship information acquisition unit 123 performs inverse Fourier transform for a sequence based on phase difference spectra ϕ(0) to ϕ(T−1) for each candidate sample number τ_{cand} from a predetermined number τₘₐₓ to a predetermined number τₘᵢₙ (for example, τₘₐₓ is a positive number and τₘᵢₙ is a negative number) to obtain a phase difference signal ψ(τ_{cand}) for each candidate sample number τ_{cand} from τₘₐₓ to τₘᵢₙ, obtains and outputs a maximum value of a correlation value γ_{cand} that is an absolute value of the phase difference signal ψ(τ_{cand}) as an inter-channel correlation value γ, obtains and outputs information indicating that the first channel is preceding as the preceding channel information in a case where τ_{cand} of when the correlation value is the maximum value is a positive value, and obtains and outputs information indicating that the second channel is preceding as the preceding channel information in a case where τ_{cand} of when the correlation value is the maximum value is a negative value (step S123). Hereinafter, an example of processing of the inter-channel relationship information acquisition unit 123 will be described in detail.

The inter-channel relationship information acquisition unit 123 first obtains the phase difference signal ψ(τ_{cand}) for each candidate sample number τ_{cand} from the predetermined number τₘₐₓ to the predetermined number τₘᵢₙ (for example, τₘₐₓ is a positive number and τₘᵢₙ is a negative number) by performing inverse Fourier transform for the sequence based on the phase difference spectra ϕ(0) to ϕ(T−1) input from the phase difference spectrum estimation unit 122 as in Equation (1-7) below for each candidate sample number τ_{cand} from τₘₐₓ to τₘᵢₙ.

$$[ Math . 7 ]$$

$$ψ ( {τ}_{cand} ) = \frac{1}{\sqrt{T}} {\sum }_{k = 0}^{T - 1} ϕ ( k ) {e}^{j \frac{2 π k {τ}_{cand}}{T}} \qquad ( 1 - 7 )$$

Each predetermined candidate sample number may be an integer value from τₘₐₓ to τₘᵢₙ, may include a fractional value or a decimal value between τₘₐₓ and τₘᵢₙ, or may not include any integer value between τₘₐₓ and τₘᵢₙ. In addition, τₘₐₓ=−τₘᵢₙ may be satisfied or may not be satisfied. Assuming that a target is an input sound signal whose preceding channel is unknown, it is preferable that τₘₐₓ be a positive number and τₘᵢₙ be a negative number.

Since the absolute value of the phase difference signal ψ(τ_{cand}) obtained by Equation (1-7) represents a kind of correlation corresponding to the likelihood of the time difference between the first channel input sound signals x₁(1), x₁(2), . . . , x₁(T) and the second channel input sound signals x₂(1), x₂(2), . . . , x₂(T), the inter-channel relationship information acquisition unit 123 uses the absolute value of the phase difference signal ψ(τ_{cand}) with respect to each candidate sample number τ_{cand} as a correlation value γ_{cand}. That is, the inter-channel relationship information acquisition unit 123 obtains and outputs the maximum value of the correlation value γ_{cand} that is the absolute value of the phase difference signal ψ(τ_{cand}) obtained in Equation (1-7) as the inter-channel correlation value γ, obtains and outputs information indicating that the first channel is preceding as the preceding channel information in a case where τ_{cand} of when the correlation value is the maximum value is a positive value, and obtains and outputs information indicating that the second channel is preceding as the preceding channel information in a case where τ_{cand} of when the correlation value is the maximum value is a negative value. In a case where τ_{cand} of when the correlation value is the maximum value is zero, the inter-channel relationship information acquisition unit 123 may obtain and output the information indicating that the first channel is preceding as the preceding channel information, or may obtain and output the information indicating that the second channel is preceding as the preceding channel information, but may obtain and output information indicating that none of the channels is preceding as the preceding channel information. Note that, instead of using the absolute value of the phase difference signal f(τ_{cand}) without change as the correlation value γ_{cand}, the inter-channel relationship information acquisition unit 123 may use a normalized value such as a relative difference from an average of absolute values of the phase difference signals respectively obtained for the plurality of candidate sample numbers, for example, before and after τ_{cand} with respect to the absolute value of the phase difference signal ψ(τ_{cand}) for each τ_{cand}. That is, the inter-channel relationship information acquisition unit 123 may obtain an average value by Equation (1-8) below using a predetermined positive number τ_{range} for each τ_{cand} and use a normalized correlation value obtained by Equation (1-9) below as γ_{cand} using the obtained average value ψ_{c}(τ_{cand}) and the phase difference signal ψ(τ_{cand})

$$[ Math . 8 ]$$

$${ψ}_{c} ( {τ}_{cand} ) = \frac{1}{2 {τ}_{range} + 1} , + {τ}_{r ( \{ η} {{\sum }_{{τ}^{′} = {τ}_{cand} - {τ}_{range}}}^{{τ}_{cand} + {τ}_{range}} \vert ψ ( {τ}^{′} ) \vert \qquad ( 1 - 8 )$$

$$[ Math . 9 ]$$

$$1 - \frac{{ψ}_{c} ( {τ}_{cand} )}{\vert ψ ( {τ}_{cand} ) \vert} \qquad ( 1 - 9 )$$

Note that the normalized correlation value obtained by Equation (1-9) is a value of 0 or more and 1 or less, and is a value having properties of being close to one as τ_{cand} is likely to be the inter-channel time difference, and being close to zero as τ_{cand} is not likely to be the inter-channel time difference.

The inter-channel correlation value γ and the preceding channel information obtained by the inter-channel relationship information acquisition unit 123 are output from the inter-channel relationship information acquisition unit 123 and input to the downmixing unit 130.

### [Downmixing Unit 130]

The downmixing unit 130 receives the first channel input sound signal input to the sound signal downmixing device 100, the second channel input sound signal input to the sound signal downmixing device 100, the inter-channel correlation value γ output from the inter-channel relationship information estimation unit 120, and the preceding channel information output from the inter-channel relationship information estimation unit 120. The downmixing unit 130 obtains and outputs a downmixed signal by performing weighted addition on the first channel input sound signal and the second channel input sound signal such that more of the input sound signal of the preceding channel of the first channel input sound signal and the second channel input sound signal is included in the downmixed signal as the inter-channel correlation value γ becomes larger (step S130).

For example, if the absolute value or the normalized value of the correlation coefficient is used as the inter-channel correlation value as in the example described above in the description of the inter-channel relationship information estimation unit 120, the inter-channel correlation value γ input from the inter-channel relationship information estimation unit 120 is a value of 0 or more and 1 or less. Therefore, the downmixing unit 130 may obtain a downmixed signal x_{M}(t) by performing weighted addition on the first channel input sound signal x₁(t) and the second channel input sound signal x₂(t) using the weight determined by the inter-channel correlation value γ for each corresponding sample number t. For example, the downmixing unit 130 may obtain the downmixed signal x_{M}(t) as x_{M}(t)=((1+γ)/2)×x₁(t)ϕ((1−γ)/2)×x₂(t) in a case where the preceding channel information is the information indicating that the first channel is preceding, that is, in a case where the first channel is preceding, and as x_{M}(t)=((1−γ)/2)×x₁(t)ϕ((1+γ)/2)×x₂(t) in a case where the preceding channel information is the information indicating that the second channel is preceding, that is, in a case where the second channel is preceding. When the downmixing unit 130 obtains the downmixed signal in this way, the smaller the inter-channel correlation value γ, that is, the smaller the correlation between the first channel input sound signal and the second channel input sound signal, the closer the downmixed signal is to the signal obtained by averaging the first channel input sound signal and the second channel input sound signal, and the larger the inter-channel correlation value γ, that is, the larger the correlation between the first channel input sound signal and the second channel input sound signal, the closer the downmixed signal is to the input sound signal of the preceding channel of the first channel input sound signal and the second channel input sound signal.

Note that, in a case where none of the channels is preceding, the downmixing unit 130 preferably obtains and outputs a downmixed signal by performing weighted addition on the first channel input sound signal and the second channel input sound signal such that the first channel input sound signal and the second channel input sound signal are included in the downmixed signal with the same weight. That is, in a case where the preceding channel information indicates that none of the channels is preceding, for example, the downmixing unit 130 may obtain a downmixed signal by performing weighted addition on the first channel input sound signal and the second channel input sound signal, and specifically, x_{M}(t)=(x₁(t)+x₂(t))/2 obtained by averaging the first channel input sound signal x₁(t) and the second channel input sound signal x₂(t) for each sample number t may be used as the downmixed signal x_{M}(t).

### Second Embodiment

A sound signal downmixing device 100 of a second embodiment changes the sound signal downmixing device 100 of the first embodiment such that the inter-channel relationship information acquisition unit 123 gives a weight for each frequency to obtain the phase difference signal ψ(τ_{cand}), and causes accuracy of estimation of the phase difference spectrum obtained by the phase difference spectrum estimation unit 122 to depend on the weight for each frequency. Hereinafter, differences of the sound signal downmixing device 100 of the second embodiment from the sound signal downmixing device 100 of the first embodiment will be described.

An inter-channel relationship information acquisition unit 123 of the second embodiment obtains a phase difference signal ψ(τ_{cand}) for each candidate sample number τ_{cand} from τₘₐₓ to τₘᵢₙ by performing inverse Fourier transform for a sequence based on estimated values ϕ(0) to ϕ(T−1) of phase difference spectra input from a phase difference spectrum estimation unit 122 as in Equation (2-1) below for each candidate sample number τ_{cand}.

$$[ Math . 10 ]$$

$$ψ ( {τ}_{cand} ) = \frac{1}{\sqrt{T}} {\sum }_{k = 0}^{T - 1} w ( k ) ϕ ( k ) {e}^{j \frac{2 π k {τ}_{cand}}{T}} \qquad ( 2 - 1 )$$

w(k) in Equation (2-1) is a weighting factor for a frequency k and is a positive value. For example, w(k) can be a value larger than 0 and equal to or smaller than 1, and can be a smaller value as k is closer to 0 or T−1 and can be a larger value as k is farther from 0 and T−1.

In the case of obtaining the phase difference signal ψ(τ_{cand}) by Equation (2-1), an influence of the accuracy of the estimation of the phase difference spectrum by the phase difference spectrum estimation unit 122 on the phase difference signal ψ(τ_{cand}) is smaller for the frequency k having a smaller weighting factor w(k). That is, the estimation accuracy by the phase difference spectrum estimation unit 122 may be lower for the frequency k having a small weighting factor w(k) than for the frequency k having a large weighting factor w(k). For example, in the case of using the phase difference spectrum estimation unit 122 of the third example, the number of divisions N of each quadrant may be smaller for the frequency k having a small weighting factor w(k) than for the frequency k having a large weighting factor w(k). Furthermore, for example, in the case of using the phase difference spectrum estimation unit 122 of the fourth example, the number of times P of performing a binary search may be smaller for the frequency k having a small weighting factor w(k) than for the frequency k having a large weighting factor w(k). Furthermore, for example, in the case of using the phase difference spectrum estimation unit 122 of the fifth example, the number of candidates Q of the phase difference spectrum may be smaller for the frequency k having a small weighting factor w(k) than for the frequency k having a large weighting factor w(k).

Note that, in the case of using the phase difference spectrum estimation unit 122 of the fourth example, the number of binary searches (the number of comparison steps) s(k) for each frequency k can be determined among the number of binary searches (the number of comparison steps) S in the entire frequency domain so as to minimize a total sum of estimation errors of arguments in the entire frequency domain. First, the number of comparison steps S in the entire frequency domain and the number of comparison steps s(k) for each frequency k are expressed by Equation (2-2) below.

$$[ Math . 11 ]$$

$$S = {\sum }_{k = 0}^{T - 1} s ( k ) \qquad ( 2 - 2 )$$

Since the estimation error of the argument of each sample is proportional to 2^{-2s(k)}, a total sum D of the estimation errors of the arguments in the entire frequency domain is expressed by Equation (2-3) below.

$$[ Math . 12 ]$$

$$D = {\sum }_{k = 0}^{T - 1} w ( k ) {2}^{- 2 s ( k )} \qquad ( 2 - 3 )$$

Therefore, to minimize the total sum D of the estimation errors of the arguments in the entire frequency domain while the number of comparison steps S in the entire frequency domain is constant, the number of comparison steps s(k) of each frequency k may be determined by Equation (2-4) below.

$$[ Math . 13 ]$$

$$s ( k ) = \frac{S}{T} + \frac{1}{2} {log}_{2} ( \frac{w ( k )}{{\prod }_{i = 0}^{T - 1} {( w ( i ) )}^{1 / T}} ) \qquad ( 2 - 4 )$$

Note that, since the weighting factor w(k) is determined in advance, in the case of using the phase difference spectrum estimation unit 122 of the fourth example, the number of binary searches P for each frequency k may be determined in advance on the basis of the number of comparison steps s(k) for each frequency k calculated by Equation (2-4). That is, the predetermined binary searches P for each frequency k may be a smaller value for the frequency k having a smaller weighting factor w(k).

### Third Embodiment

In the first embodiment and the second embodiment, the modes in which the phase difference spectrum estimation processing of the present invention is applied to the sound signal downmixing device have been described. However, phase difference spectrum estimation processing of the present invention may be applied to an inter-channel relationship information estimation device that estimates information indicating a relationship between a first channel input sound signal and a second channel input sound signal. This mode will be described as a third embodiment.

### <<Inter-channel Relationship Information Estimation Device 120>>

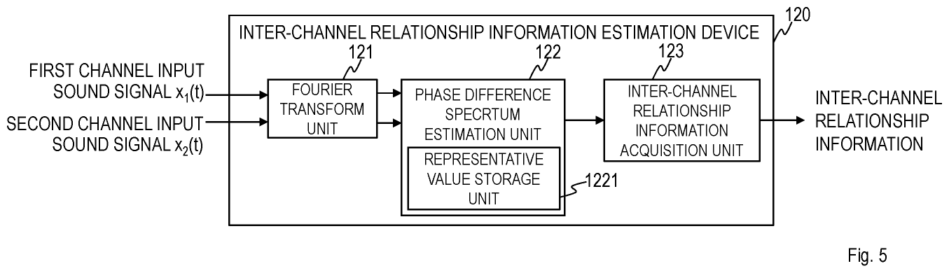

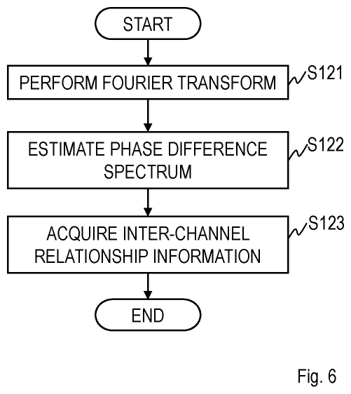

As illustrated in FIG. 5, an inter-channel relationship information estimation device 120 according to the third embodiment includes a Fourier transform unit 121, a phase difference spectrum estimation unit 122, and an inter-channel relationship information acquisition unit 123. That is, the inter-channel relationship information estimation device 120 includes a phase difference spectrum estimation device 200 of a fourth embodiment to be described below as the phase difference spectrum estimation unit 122. The inter-channel relationship information estimation device 120 according to the third embodiment obtains and outputs inter-channel relationship information that is information indicating a relationship between input sound signals of two channels from input sound signals of two-channel stereo in a time domain in units of frames having a predetermined time length of 20 ms, for example. The sound signals of two-channel stereo in the time domain input to the inter-channel relationship information estimation device 120 are, for example, digital vocal sound signals or acoustic signals obtained by respectively collecting sound such as vocal sound and music with two microphones and performing AD conversion, and includes a first channel input sound signal and a second channel input sound signal. The inter-channel relationship information output from the inter-channel relationship information estimation device 120 is input to a device that encodes the sound signal, a device that processes the sound signal, or the like. The inter-channel relationship information estimation device 120 according to the third embodiment performs processing in steps S121, S122, and S123 illustrated in FIG. 6 for each frame. Hereinafter, the inter-channel relationship information estimation device 120 according to the third embodiment will be described with reference to the description of the first embodiment and the second embodiment as appropriate.

### [Fourier Transform Unit 121]

The Fourier transform unit 121 is similar to the Fourier transform unit 121 of the first embodiment. The Fourier transform unit 121 obtains a frequency spectrum X₁(k) of the first channel and a frequency spectrum X₂(k) of the second channel at each frequency k from 0 to T−1 by performing Fourier transform for each of first channel input sound signals x₁(1), x₁(2), . . . , x₁(T) and second channel input sound signals x₂(1), x₂(2), . . . , x₂(T) (step S121).

### [Phase Difference Spectrum Estimation Unit 122]

The phase difference spectrum estimation unit 122 is similar to the phase difference spectrum estimation unit 122 of the first embodiment. The phase difference spectrum estimation unit 122 includes a representative value storage unit 1221 that stores in advance a plurality of phase difference spectrum representative values, which are values on a circumference of a unit circle of a complex plane and have different arguments on the complex plane. The phase difference spectrum estimation unit 122 selects one of the plurality of phase difference spectrum representative values stored in the representative value storage unit 1221 on the basis of a relationship between a value of a real part u(k) and a value of an imaginary part v(k) of a product Y(k) of the frequency spectrum X₁(k) of the first channel and a complex conjugate ⁻X₂(k) of the frequency spectrum X₂(k) of the second channel and obtains the selected representative value as a phase difference spectrum ϕ(k) (step S122). Specific examples of the phase difference spectrum estimation unit 122 are as described in the first to fifth examples and the modifications thereof of the phase difference spectrum estimation unit 122 of the first embodiment and in the second embodiment.

### [Inter-channel Relationship Information Acquisition Unit 123]

The inter-channel relationship information acquisition unit 123 is similar to the phase difference spectrum estimation unit 122 of the first embodiment. Note that what the inter-channel relationship information acquisition unit 123 outputs as the inter-channel relationship information may be at least one of an inter-channel correlation value γ, preceding channel information, or an inter-channel time difference to be described below. That is, the inter-channel relationship information acquisition unit 123 first performs inverse Fourier transform for a sequence based on phase difference spectra ϕ(0) to ϕ(T−1) for each candidate sample number τ_{cand} from a predetermined number τₘₐₓ to a predetermined number τₘᵢₙ to obtain a phase difference signal ψ(τ_{cand}) for each candidate sample number τ_{cand} from τₘₐₓ to τₘᵢₙ, and obtains a maximum value of a correlation value γ_{cand} that is an absolute value of the phase difference signal ψ(τ_{cand}). Next, in the case of outputting the inter-channel correlation value γ, the inter-channel relationship information acquisition unit 123 obtains and outputs the maximum value of the correlation value γ_{cand}, which is the absolute value of the phase difference signal ψ(τ_{cand}), as the inter-channel correlation value γ. Further, in the case of outputting the inter-channel time difference, the inter-channel relationship information acquisition unit 123 obtains τ_{cand} of when the correlation value is the maximum value as the inter-channel time difference and outputs the inter-channel time difference. Further, in the case of outputting the preceding channel information, the inter-channel relationship information acquisition unit 123 obtains information indicating that the first channel is preceding as the preceding channel information in a case where τ_{cand} of when the correlation value is the maximum value is a positive value, and obtains information indicating that the second channel is preceding as the preceding channel information in a case where τ_{cand} of when the correlation value is the maximum value is a negative value. (step S123)

### Fourth Embodiment

As can be seen from the description of the modes in which the phase difference spectrum estimation processing of the present invention is applied to the sound signal downmixing device in the first embodiment and the second embodiment, and the description of the mode in which the phase difference spectrum estimation processing of the present invention is applied to the inter-channel relationship information estimation device in the third embodiment, in short, a phase difference spectrum estimation device that is an independent device may perform the phase difference spectrum estimation processing of the present invention. This mode will be described as a fourth embodiment.

### <<Phase Difference Spectrum Estimation Device 200>>

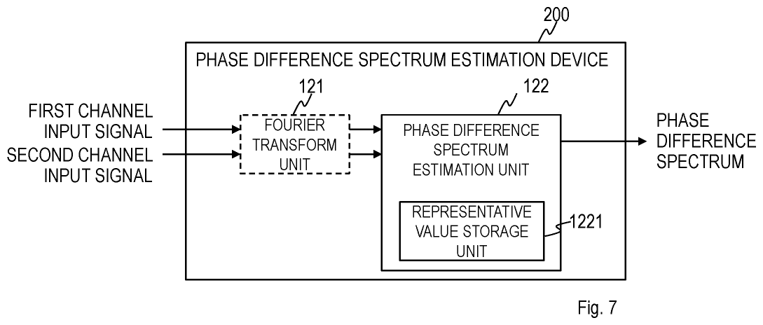

As illustrated in FIG. 7, a phase difference spectrum estimation device 200 according to the fourth embodiment includes a Fourier transform unit 121 and a phase difference spectrum estimation unit 122. The phase difference spectrum estimation device 200 of the fourth embodiment obtains an estimated value of a phase difference spectrum of each frequency in a frequency domain from a first channel input signal and a second channel input signal that are input signals of two channels, and outputs the estimated value. An example of the signals of two channels input to the phase difference spectrum estimation device 200 are, for example, sound signals in the time domain of two-channel stereo in units of frames having a predetermined time length of 20 ms, but the signals of two channels input to the phase difference spectrum estimation device 200 are not limited to sound signals, and may be image signals or any signals. In the case where the signals input to the phase difference spectrum estimation device 200 are sound signals in the time domain of two-channel stereo, the sound signals in the time domain are, for example, digital vocal sound signals or acoustic signals obtained by respectively collecting sound such as vocal sound and music with two microphones and performing AD conversion, and include a first channel input sound signal and a second channel input sound signal. The phase difference spectrum output from the phase difference spectrum estimation device 200 is input to a device that estimates the inter-channel relationship information using the phase difference spectrum, a device that downmixes signals, an encoding device, a signal processing device, and the like.

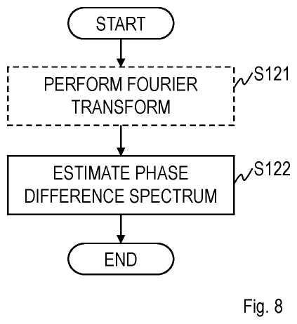

The phase difference spectrum estimation device 200 of the fourth embodiment performs processing of steps S121 and S122 illustrated in FIG. 8 for each predetermined unit for, for example, each frame in the case of a sound signal. Hereinafter, the phase difference spectrum estimation device 200 of the fourth embodiment will be described with reference to the description of the first embodiment as appropriate, where the predetermined unit is T samples, the first channel input signals are x₁(1), x₁(2), . . . , x₁(T), and the second channel input signals are x₂(1), x₂(2), . . . , x₂(T).

### [Fourier Transform Unit 121]

The Fourier transform unit 121 is similar to the Fourier transform unit 121 of the first embodiment. The Fourier transform unit 121 obtains a frequency spectrum X₁(k) of the first channel and a frequency spectrum X₂(k) of the second channel at each frequency k from 0 to T−1 by performing Fourier transform for each of first channel input signals x₁(1), x₁(2), . . . , x₁(T) and second channel input signals x₂(1), x₂(2), . . . , x₂(T) (step S121)

### [Phase Difference Spectrum Estimation Unit 122]

The phase difference spectrum estimation unit 122 is similar to the phase difference spectrum estimation unit 122 of the first embodiment. The phase difference spectrum estimation unit 122 includes a representative value storage unit 1221 that stores in advance a plurality of phase difference spectrum representative values, which are values on a circumference of a unit circle of a complex plane and have different arguments on the complex plane. The phase difference spectrum estimation unit 122 selects one of the plurality of phase difference spectrum representative values stored in the representative value storage unit 1221 on the basis of a relationship between a value of a real part u(k) and a value of an imaginary part v(k) of a product Y(k) of the frequency spectrum X₁(k) of the first channel and a complex conjugate ⁻X₂(k) of the frequency spectrum X₂(k) of the second channel and obtains the selected representative value as a phase difference spectrum ϕ(k) (step S122). Specific examples of the phase difference spectrum estimation unit 122 are as described in the first to fifth examples and the modifications thereof of the phase difference spectrum estimation unit 122 of the first embodiment, and are, for example, as follows.

For example, the phase difference spectrum estimation unit 122 determines, using P as a predetermined integer of 0 or more, in which quadrant Y(k) exists, obtains the phase difference spectrum representative value for the quadrant in which Y(k) exists among the phase difference spectrum representative values stored in the representative value storage unit, as the phase difference spectrum ϕ(k), when P=0, and specifies an argument range in which Y(k) exists by performing a binary search in the argument range P times with respect to the quadrant in which Y(k) exists, and obtains the phase difference spectrum representative value for the specified argument range among the phase difference spectrum representative values stored in the representative value storage unit, as the phase difference spectrum ϕ(k), when P≠0.

More specifically, the phase difference spectrum estimation unit 122 obtains the phase difference spectrum ϕ(k) by following first to sixth substeps with P as a predetermined integer of 0 or more.

First substep: the phase difference spectrum estimation unit 122 determines in which quadrant of the complex plane Y(k) is located on the basis of whether the sign of u(k) or u(k) is a positive value or a negative value and whether the sign of v(k) or v(k) is a positive value or a negative value with p=0, and obtains the argument representative value of the argument range of the quadrant in which Y(k) exists.

Second substep: next to the first substep, in the case of p=P, the phase difference spectrum estimation unit 122 obtains, as the phase difference spectrum ϕ(k), the complex value of the point on the circumference of the unit circle of which the argument of the complex plane is the argument representative value obtained in the first substep, among the phase difference spectrum representative values stored in the representative value storage unit.

Third substep: next to the first substep, in the case of not p=P, the phase difference spectrum estimation unit 122 sets 1 as new p, and obtains the argument range of the quadrant in which Y(k) exists as a search range of the next substep (the fourth substep to be performed next) and obtains the absolute value of the tangent of the argument representative value of the search range.

Fourth substep: the phase difference spectrum estimation unit 122 determines that Y(k) exists in a range on the real axis side in the search range obtained in the immediately preceding substep, and obtains the argument representative value in the range on the real axis side in the search range obtained in the immediately preceding substep in a case where a value obtained by multiplying |u(k)| by the absolute value of the tangent of the argument representative value of the search range obtained in the immediately preceding substep (third substep or sixth substep) is larger than |v(k)|, and determines that Y(k) exists in a range on the imaginary axis side in the search range obtained in the immediately preceding substep, and obtains the argument representative value in the range on the imaginary axis side in the search range obtained in the immediately preceding substep in a case where a value obtained by multiplying |u(k)| by the absolute value of the tangent of the argument representative value of the search range obtained in the immediately preceding substep is smaller than |v(k)|.

Fifth substep: next to the fourth substep, in the case of p=P, the phase difference spectrum estimation unit 122 obtains, as the phase difference spectrum ϕ(k), the complex value of the point on the circumference of the unit circle of which the argument of the complex plane is the argument representative value obtained in the fourth substep, among the phase difference spectrum representative values stored in the representative value storage unit.

Sixth substep: next to the fourth substep, in the case of not p=P, the phase difference spectrum estimation unit 122 sets a value obtained by adding 1 to p as new p, and obtains the argument range in the range where Y(k) exists determined in the fourth substep as a search range of the fourth substep to be performed next and obtains the absolute value of the tangent of the argument representative value obtained in the fourth substep as the absolute value of the tangent of the argument representative value in the search range of the fourth substep to be performed next.

Alternatively, the phase difference spectrum estimation unit 122 obtains the phase difference spectrum ϕ(k) by the following first to sixth substeps with P as a predetermined integer of 0 or more.

First substep: the phase difference spectrum estimation unit 122 determines in which quadrant of the complex plane Y(k) is located on the basis of whether the sign of u(k) or u(k) is a positive value or a negative value and whether the sign of v(k) or v(k) is a positive value or a negative value with p=0, and obtains the median of the argument range of the quadrant in which Y(k) exists.

Second substep: when p=P is satisfied next to the first substep, the phase difference spectrum estimation unit 122 obtains, as the phase difference spectrum ϕ(k), the complex value of the point on the circumference of the unit circle of which the argument of the complex plane is the median obtained in the first substep, among the phase difference spectrum representative values stored in the representative value storage unit.

Third substep: next to the first substep, in the case of not p=P, the phase difference spectrum estimation unit 122 sets 1 as new p, and obtains the argument range of the quadrant in which Y(k) exists as a search range of the next substep (the fourth substep to be performed next).

Fourth substep: in a case of being performed next to the third substep, in the case where |u(k)| is larger than |v(k)|, the phase difference spectrum estimation unit 122 determines that Y(k) exists in the half range on the real axis side of the search range obtained in the third substep, and obtains the argument representative value in the half range on the real axis side of the search range obtained in the third substep, and in the case where |u(k)| is smaller than |v(k)|, the phase difference spectrum estimation unit 122 determines that Y(k) exists in the half range on the imaginary axis side of the search range obtained in the third substep, and obtains the argument representative value in the half range on the imaginary axis side of the search range obtained in the third substep; and in a case of being performed next to the sixth substep, in a case where the value obtained by multiplying |u(k)| by the absolute value of the tangent of the argument representative value of the search range obtained in the sixth substep is larger than |v(k)|, the phase difference spectrum estimation unit 122 determines that Y(k) exists in the range on the real axis side in the search range obtained in the sixth substep, and obtains the argument representative value of the range on the real axis side in the search range obtained in the sixth substep, and in a case where the value obtained by multiplying |u(k)| by the absolute value of the tangent of the argument representative value of the search range obtained in the sixth substep is smaller than |v(k)|, the phase difference spectrum estimation unit 122 determines that Y(k) exists in the range on the imaginary axis side in the search range obtained in the sixth substep, and obtains the argument representative value of the range on the imaginary axis side in the search range obtained in the sixth substep.

Fifth substep: next to the fourth substep, in the case of p=P, the phase difference spectrum estimation unit 122 obtains, as the phase difference spectrum ϕ(k), the complex value of the point on the circumference of the unit circle of which the argument of the complex plane is the argument representative value obtained in the fourth substep, among the phase difference spectrum representative values stored in the representative value storage unit.

Sixth substep: next to the fourth substep, in the case of not p=P, the phase difference spectrum estimation unit 122 sets a value obtained by adding 1 to p as new p, and obtains the argument range in the range where Y(k) exists determined in the fourth substep as a search range of the fourth substep to be performed next and obtains the absolute value of the tangent of the argument representative value obtained in the fourth substep as the absolute value of the tangent of the argument representative value in the search range of the fourth substep to be performed next.

Alternatively, the phase difference spectrum estimation unit 122 obtains the phase difference spectrum ϕ(k) by the following first to sixth substeps with P as a predetermined integer of 0 or more.

First substep: the phase difference spectrum estimation unit 122 determines in which quadrant of the complex plane Y(k) is located on the basis of whether the sign of u(k) or u(k) is a positive value or a negative value and whether the sign of v(k) or v(k) is a positive value or a negative value with p=0, and obtains the argument representative value of the argument range of the quadrant in which Y(k) exists.

Second substep: next to the first substep, in the case of p=P, the phase difference spectrum estimation unit 122 obtains, as the phase difference spectrum ϕ(k), the complex value of the point on the circumference of the unit circle of which the argument of the complex plane is the argument representative value obtained in the first substep, among the phase difference spectrum representative values stored in the representative value storage unit.

Third substep: next to the first substep, in the case of not p=P, the phase difference spectrum estimation unit 122 sets 1 as new p, and obtains the argument range of the quadrant in which Y(k) exists as a search range of the next substep (the fourth substep to be performed next) and obtains the absolute value of the cotangent of the argument representative value of the search range.

Fourth substep: the phase difference spectrum estimation unit 122 determines that Y(k) exists in a range on the real axis side in the search range obtained in the immediately preceding substep, and obtains the argument representative value in the range on the real axis side in the search range obtained in the immediately preceding substep in a case where |u(k)| is larger than a value obtained by multiplying |v(k)| by the absolute value of the cotangent of the argument representative value of the search range obtained in the immediately preceding substep (third substep or sixth substep), and determines that Y(k) exists in a range on the imaginary axis side in the search range obtained in the immediately preceding substep, and obtains the argument representative value in the range on the imaginary axis side in the search range obtained in the immediately preceding substep in a case where |u(k)| is smaller than a value obtained by multiplying |v(k)| by the absolute value of the cotangent of the argument representative value of the search range obtained in the immediately preceding substep.

Fifth substep: next to the fourth substep, in the case of p=P, the phase difference spectrum estimation unit 122 obtains, as the phase difference spectrum ϕ(k), the complex value of the point on the circumference of the unit circle of which the argument of the complex plane is the argument representative value obtained in the fourth substep, among the phase difference spectrum representative values stored in the representative value storage unit.

Sixth substep: next to the fourth substep, in the case of not p=P, the phase difference spectrum estimation unit 122 sets a value obtained by adding 1 to p as new p, and obtains the argument range in the range where Y(k) exists determined in the fourth substep as a search range of the fourth substep to be performed next and obtains the absolute value of the cotangent of the argument representative value obtained in the fourth substep as the absolute value of the cotangent of the argument representative value in the search range of the fourth substep to be performed next.

Alternatively, the phase difference spectrum estimation unit 122 obtains the phase difference spectrum ϕ(k) by the following first to sixth substeps with P as a predetermined integer of 0 or more.

First substep: the phase difference spectrum estimation unit 122 determines in which quadrant of the complex plane Y(k) is located on the basis of whether the sign of u(k) or u(k) is a positive value or a negative value and whether the sign of v(k) or v(k) is a positive value or a negative value with p=0, and obtains the median of the argument range of the quadrant in which Y(k) exists.

Second substep: when p=P is satisfied next to the first substep, the phase difference spectrum estimation unit 122 obtains, as the phase difference spectrum ϕ(k), the complex value of the point on the circumference of the unit circle of which the argument of the complex plane is the median obtained in the first substep, among the phase difference spectrum representative values stored in the representative value storage unit.

Third substep: next to the first substep, in the case of not p=P, the phase difference spectrum estimation unit 122 sets 1 as new p, and obtains the argument range of the quadrant in which Y(k) exists as a search range of the next substep (the fourth substep to be performed next).

Fourth substep: in a case of being performed next to the third substep, in the case where |u(k)| is larger than |v(k)|, the phase difference spectrum estimation unit 122 determines that Y(k) exists in the half range on the real axis side of the search range obtained in the third substep, and obtains the argument representative value in the half range on the real axis side of the search range obtained in the third substep, and in the case where |u(k)| is smaller than |v(k)|, the phase difference spectrum estimation unit 122 determines that Y(k) exists in the half range on the imaginary axis side of the search range obtained in the third substep, and obtains the argument representative value in the half range on the imaginary axis side of the search range obtained in the third substep; and in a case of being performed next to the sixth substep, in a case where |u(k)| is larger than the value obtained by multiplying |v(k)| by the absolute value of the cotangent of the argument representative value in the search range obtained in the sixth substep, the phase difference spectrum estimation unit 122 determines that Y(k) exists in the range on the real axis side in the search range obtained in the sixth substep, and obtains the argument representative value in the range on the real axis side in the search range obtained in the sixth substep, and in a case where |u(k)| is smaller than the value obtained by multiplying |v(k)| by the absolute value of the cotangent of the argument representative value in the search range obtained in the sixth substep, the phase difference spectrum estimation unit 122 determines that Y(k) exists in the range on the imaginary axis side in the search range obtained in the sixth substep, and obtains the argument representative value in the range on the imaginary axis side in the search range obtained in the sixth substep

Fifth substep: next to the fourth substep, in the case of p=P, the phase difference spectrum estimation unit 122 obtains, as the phase difference spectrum ϕ(k), the complex value of the point on the circumference of the unit circle of which the argument of the complex plane is the argument representative value obtained in the fourth substep, among the phase difference spectrum representative values stored in the representative value storage unit.

Sixth substep: next to the fourth substep, in the case of not p=P, the phase difference spectrum estimation unit 122 sets a value obtained by adding 1 to p as new p, and obtains the argument range in the range where Y(k) exists determined in the fourth substep as a search range of the fourth substep to be performed next and obtains the absolute value of the cotangent of the argument representative value obtained in the fourth substep as the absolute value of the cotangent of the argument representative value in the search range of the fourth substep to be performed next.

For example, the phase difference spectrum estimation unit 122 obtains, where N is an integer of 2 or more, π is each integer of 1 or more and N or less, and θ is the argument of Y(k), in a case of (n−1)π/2N <θ<nπ/2N, a complex value of the point on the circumference of the unit circle of which the argument on the complex plane is (2n−1)π/4N among the phase difference spectrum representative values stored in the representative value storage unit, as the phase difference spectrum ϕ(k).

For example, the phase difference spectrum estimation unit 122 obtains the representative value ϕ(q) corresponding to tan θ(ϕ(q)) with the smallest |u(k)×tan θ(ϕ(q))−|v(k)|, as the phase difference spectrum ϕ(k), where Q is an integer of 2 or more, q is each integer of 1 or more and Q or less, each representative value stored in the representative value storage unit is ϕ(q), and the argument of ϕ(q) on the complex plane is θ(ϕ(q)).

Note that signals of two channels in a frequency domain may be input to the phase difference spectrum estimation device 200. In this case, since the phase difference spectrum estimation device 200 does not need to perform step S121, the phase difference spectrum estimation device 200 may not include the Fourier transform unit 121. That is, the phase difference spectrum estimation device 200 includes only the phase difference spectrum estimation unit 122, and may obtain the phase difference spectrum ϕ(k) of each frequency k by performing the above-described step S122 with the signals in the frequency domain of the first channel input to the phase difference spectrum estimation device 200 as X₁(0), X₁(2), . . . , x₁(T−1) and the signals in the frequency domain of the second channel input to the phase difference spectrum estimation device 200 as X₂(0), X₂(2), . . . , x₂(T−1).

### Fifth Embodiment

An encoding device that encodes a signal using the phase difference spectrum obtained by the phase difference spectrum estimation device 200 of the fourth embodiment may be configured, and this mode will be described as a fifth embodiment.

### <<Signal Encoding Device 300>>

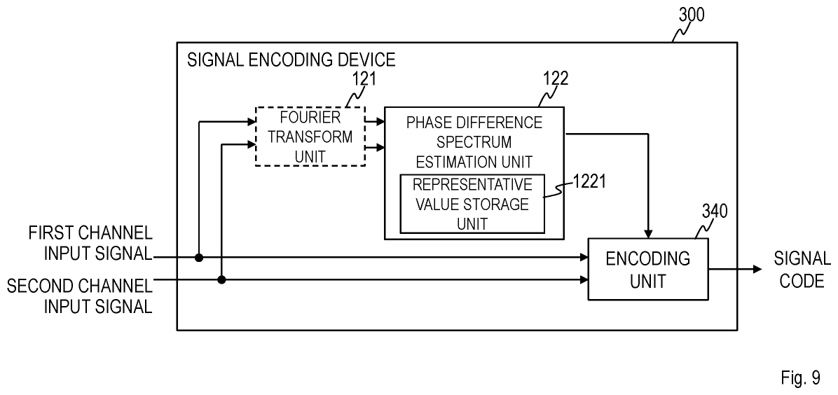

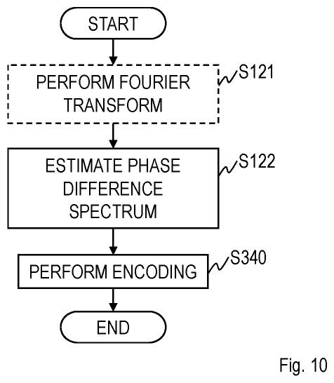

As illustrated in FIG. 9, a signal encoding device 300 of the fifth embodiment includes at least a phase difference spectrum estimation unit 122 and an encoding unit 340. That is, the signal encoding device 300 includes the phase difference spectrum estimation device 200 of the fourth embodiment as the phase difference spectrum estimation unit 122. The signal encoding device 300 obtains a signal code, which is a code representing an input signal, from a first channel input signal and a second channel input signal, which are input signals of two channels, and outputs the signal code. The signal input to the signal encoding device 300 is similar to the signal input to the phase difference spectrum estimation device 200 of the fourth embodiment. The signal code output from the signal encoding device 300 is input to a signal decoding device. In a case where the signal input to the signal encoding device 300 is a signal in a frequency domain, the signal encoding device 300 performs processing of step S122 and step S340 illustrated in FIG. 10 for each predetermined unit. In a case where the signal input to the signal encoding device 300 is a signal in a time domain, the signal encoding device 300 also includes a Fourier transform unit 121 as indicated by the broken line in FIG. 9, and also performs step S121 as indicated by the broken line in FIG. 10. Step S121 performed by the Fourier transform unit 121 and step S122 performed by the phase difference spectrum estimation unit 122 are similar to those in the fourth embodiment.

### [Encoding Unit 340]

The encoding unit 340 encodes the first channel input signal and the second channel input signal input to the encoding device 300 using the phase difference spectrum obtained by the phase difference spectrum estimation unit 122, obtains the signal code, and outputs the signal code (step S340). Encoding processing performed by the encoding unit 340 may be any encoding processing as long as the encoding processing is an encoding process using the phase difference spectrum obtained by the phase difference spectrum estimation unit 122.

### Sixth Embodiment

A signal processing device that processes a signal using the phase difference spectrum obtained by the phase difference spectrum estimation device 200 of the fourth embodiment may be configured, and this mode will be described as a sixth embodiment.

### <<Signal Processing Device 400>>

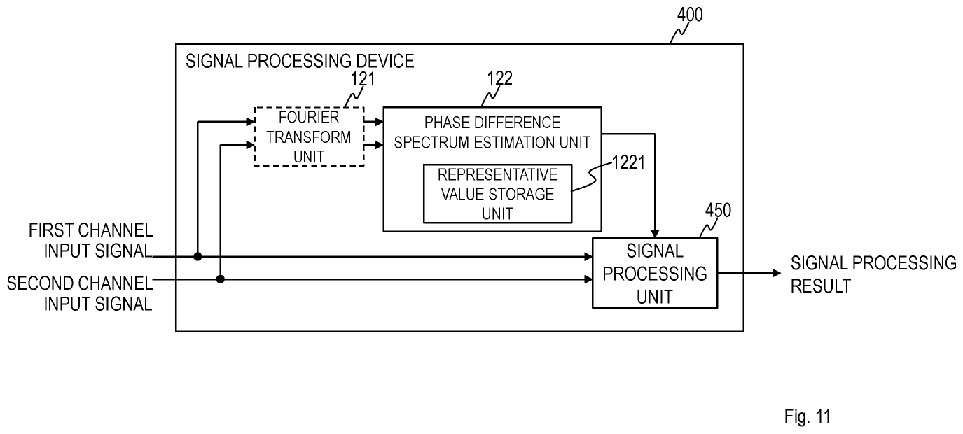

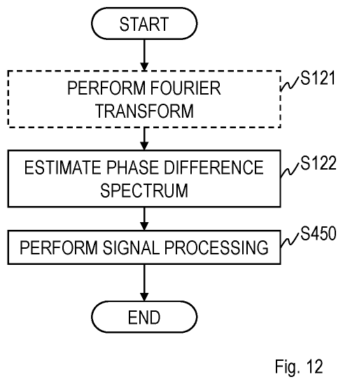

As illustrated in FIG. 11, a signal processing device 400 of the sixth embodiment includes at least a phase difference spectrum estimation unit 122 and a signal processing unit 450. That is, the signal processing device 400 includes the phase difference spectrum estimation device 200 of the fourth embodiment as the phase difference spectrum estimation unit 122. The signal processing device 400 performs signal processing for a first channel input signal and a second channel input signal that are input signals of two channels to obtain a signal processing result, and outputs the signal processing result. The signal input to the signal processing device 400 is similar to the signal input to the phase difference spectrum estimation device 200 of the fourth embodiment. In a case where the signal input to the signal processing device 400 is a signal in a frequency domain, the signal processing device 400 performs processing of step S122 and step S450 illustrated in FIG. 12 for each predetermined unit. In a case where the signal input to the signal processing device 400 is a signal in a time domain, the signal processing device 400 also includes a Fourier transform unit 121 as indicated by the broken line in FIG. 11, and also performs step S121 as indicated by the broken line in FIG. 12. Step S121 performed by the Fourier transform unit 121 and step S122 performed by the phase difference spectrum estimation unit 122 are similar to those in the fourth embodiment.

### [Signal Processing Unit 450]

The signal processing unit 450 performs signal processing for the first channel input signal and the second channel input signal input to the signal processing device 400 using the phase difference spectrum obtained by the phase difference spectrum estimation unit 122 to obtain a signal processing result, and outputs the signal processing result (step S450). The signal processing performed by the signal processing unit 450 may be any signal processing as long as the signal processing is a signal process using the phase difference spectrum obtained by the phase difference spectrum estimation unit 122.

### <Supplement>

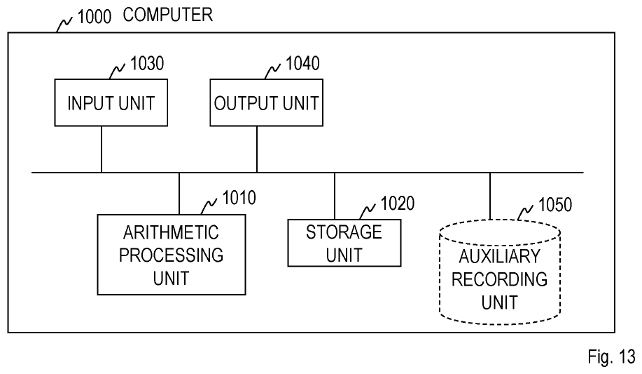

The processing of each unit of each of the devices described above may be implemented by a computer, in which case, processing content of a function that each of the devices should have is described by a program. By causing a storage unit 1020 of a computer 1000 illustrated in FIG. 13 to read this program and causing an arithmetic processing unit 1010, an input unit 1030, an output unit 1040, and the like to execute the program, various processing functions in each of the foregoing devices are implemented on the computer.

The device of the present invention includes, for example, as a single hardware entity, an input unit to which a signal can be input from the outside of the hardware entity, an output unit that can output a signal to the outside of the hardware entity, a communication unit to which a communication device (for example, a communication cable) capable of communicating to the outside of the hardware entity can be connected, a CPU (Central Processing Unit, which may include a cache memory, a register, or the like), a RAM or a ROM that is a memory, an external storage device that is a hard disk, and a bus connected to be able to exchange data among the input unit, the output unit, the communication unit, the CPU, the RAM, the ROM, and the external storage device. A device (drive) or the like that can write and read data in and from a recording medium such as a CD-ROM may be provided in the hardware entity as necessary. Examples of a physical entity including such a hardware resource include a general-purpose computer.

The external storage device of the hardware entity stores a program required to implement the above-described functions, data required to process the program, and the like (the present invention is not limited to the external storage device and the program may be stored, for example, in a ROM which is a read-only storage device). Data or the like obtained by processing the program is appropriately stored in a RAM, an external storage device, or the like.

In the hardware entity, each program stored in the external storage device (or ROM or the like) and data required to process each program are read to a memory as necessary and are appropriately interpreted and processed by the CPU. As a result, the CPU implements a predetermined function (each component represented as . . . unit, . . . means, or the like). That is, each component of the embodiment of the present invention may be configured by processing circuitry.

As described above, when the processing function of the hardware entity (the device according to the present invention) described in the foregoing embodiment is implemented by a computer, processing content of the function of the hardware entity is described by a program. In addition, as the computer executes the program, the processing function of the hardware entity is implemented on the computer.

The program in which the processing content is written can be recorded in a computer-readable recording medium. The computer-readable recording medium is, for example, a non-transitory recording medium and is specifically a magnetic recording device, an optical disk, or the like.

In addition, distribution of the program is performed by, for example, selling, transferring, or renting a portable recording medium such as a DVD or a CD-ROM on which the program is recorded. Further, a configuration may also be employed in which the program is stored in a storage device in a server computer and the program is distributed by transferring the program from the server computer to other computers via a network.

For example, the computer that executes such a program first temporarily stores the program recorded in the portable recording medium or the program transferred from the server computer in an auxiliary recording unit 1050 that is a non-transitory storage device of the computer. Then, at the time of performing processing, the computer reads the program stored in the auxiliary recording unit 1050 that is the non-temporary storage device of the computer into the storage unit 1020 and performs processing in accordance with the read program. In addition, as another embodiment of the program, the computer may directly read the program from the portable recording medium into the storage unit 1020 and perform processing in accordance with the program, and furthermore, the computer may sequentially perform processing in accordance with a received program each time the program is transferred from the server computer to the computer. In addition, the above-described processing may be performed by a so-called ASP (Application Service Provider) type service that implements a processing function only by a performance instruction and result acquisition without transferring the program from the server computer to the computer. Note that the program in this mode includes information that is to be used in processing by an electronic computer and is equivalent to the program (data and the like that are not direct commands to the computer but have properties that define the processing to be performed by the computer).

In addition, although the present device is configured by executing a predetermined program on the computer in the present embodiment, at least part of the processing content may be implemented by hardware.

The present invention is not limited to the above-described embodiment and can be appropriately modified without departing from the gist of the present invention.

1. A phase difference spectrum estimation method for estimating a phase difference spectrum ϕ(k) of a frequency spectrum X₁(k) of an input signal of a first channel and a frequency spectrum X₂(k) of an input signal of a second channel with respect to a frequency k, the phase difference spectrum estimation method comprising:
a phase difference spectrum estimation step of selecting one of a plurality of phase difference spectrum representative values, the representative values being stored in a representative value storage circuitry, being values on a circumference of a unit circle of a complex plane, and being values having different arguments on the complex plane, on a basis of a relationship between a value of a real part u(k) and a value of an imaginary part v(k) of a product Y(k) of the frequency spectrum X₁(k) of the first channel and a complex conjugate ⁻X₂(k) of the frequency spectrum X₂(k) of the second channel, and obtaining the selected representative value as the phase difference spectrum ϕ(k).

2. The phase difference spectrum estimation method according to claim 1, wherein
the phase difference spectrum estimation step includes,
using P as a predetermined integer of 0 or more,
determining in which quadrant Y(k) exists,
obtaining the phase difference spectrum representative value for the quadrant in which Y(k) exists among the phase difference spectrum representative values stored in the representative value storage circuitry, as the phase difference spectrum ϕ(k), when P=0, and
specifying an argument range in which Y(k) exists by performing a binary search in the argument range P times with respect to the quadrant in which Y(k) exists, and obtaining the phase difference spectrum representative value for the specified argument range among the phase difference spectrum representative values stored in the representative value storage circuitry, as the phase difference spectrum ϕ(k), when P≠0.

3. The phase difference spectrum estimation method according to claim 1, wherein
the phase difference spectrum estimation step is performed by,
using P as a predetermined integer of 0 or more,
a first substep of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining an argument representative value in an argument range of the quadrant in which Y(k) exists,
a second substep of obtaining a complex value of a point on the circumference of the unit circle of which the argument of the complex plane is the argument representative value obtained in the first substep, of the phase difference spectrum representative values stored in the representative value storage circuitry, as the phase difference spectrum ϕ(k), in a case of p=P, next to the first substep,
a third substep of obtaining an argument range of the quadrant in which Y(k) exists as a search range of the next substep, setting 1 as new p, and obtaining an absolute value of a tangent of the argument representative value in the search range, in a case of not p=P, next to the first substep,
a fourth substep of determining that Y(k) exists in a range on a real axis side in the search range obtained in the immediately preceding substep, and obtaining the argument representative value in the range on the real axis side in the search range obtained in the immediately preceding substep, in a case where a value obtained by multiplying |u(k)| by the absolute value of the tangent of the argument representative value in the search range obtained in the immediately preceding substep is larger than |v(k)|, and determining that Y(k) exists in a range on an imaginary axis side in the search range obtained in the immediately preceding substep, and obtaining the argument representative value in the range on the imaginary axis side in the search range obtained in the immediately preceding substep, in a case where the value obtained by multiplying |u(k)| by the absolute value of the tangent of the argument representative value in the search range obtained in the immediately preceding substep is smaller than |v(k)|,
a fifth substep of obtaining a complex value of a point on the circumference of the unit circle of which the argument of the complex plane is the argument representative value obtained in the fourth substep, of the phase difference spectrum representative values stored in the representative value storage circuitry, as the phase difference spectrum ϕ(k), in the case of p=P, next to the fourth substep, and
a sixth substep of obtaining an argument range in the range in which Y(k) exists determined in the fourth substep as the search range of the fourth substep to be performed next, and obtaining the absolute value of the tangent of the argument representative value obtained in the fourth substep as the absolute value of the tangent of the argument representative value in the search range of the fourth substep to be performed next, setting a value obtained by adding 1 to p as new p, in the case of not p=P, next to the fourth substep.

4. The phase difference spectrum estimation method according to claim 1, wherein
the phase difference spectrum estimation step is performed by,
using P as a predetermined integer of 0 or more,
a first substep of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining a median in an argument range of the quadrant in which Y(k) exists,
a second substep of obtaining a complex value of a point on the circumference of the unit circle of which the argument of the complex plane is the median obtained in the first substep, of the phase difference spectrum representative values stored in the representative value storage circuitry, as the phase difference spectrum ϕ(k), in a case of p=P, next to the first substep,
a third substep of obtaining an argument range of the quadrant in which Y(k) exists as a search range of the next substep, setting 1 as new p, in a case of not p=P, next to the first substep,
a fourth substep of, in a case of being performed next to the third substep, determining that Y(k) exists in a half range on a real axis side in the search range obtained in the third substep, and obtaining the argument representative value in the half range on the real axis side in the search range obtained in the third substep, in a case where |u(k)| is larger than |v(k)|, and determining that Y(k) exists in a half range on an imaginary axis side in the search range obtained in the third substep, and obtaining the argument representative value in the half range on the imaginary axis side in the search range obtained in the third substep, in a case where |u(k)| is smaller than |v(k)|, and,
in a case of being performed next to a sixth substep, determining that Y(k) exists in a range on a real axis side in the search range obtained in the sixth substep, and obtaining the argument representative value in the range on the real axis side in the search range obtained in the sixth substep, in a case where a value obtained by multiplying |u(k)| by the absolute value of the tangent of the argument representative value in the search range obtained in the sixth substep is larger than |v(k)|, and determining that Y(k) exists in a range on an imaginary axis side in the search range obtained in the sixth substep, and obtaining the argument representative value in the range on the imaginary axis side in the search range obtained in the sixth substep, in a case where the value obtained by multiplying |u(k)| by the absolute value of the tangent of the argument representative value in the search range obtained in the sixth substep is smaller than |v(k)|,
a fifth substep of obtaining a complex value of a point on the circumference of the unit circle of which the argument of the complex plane is the argument representative value obtained in the fourth substep, of the phase difference spectrum representative values stored in the representative value storage circuitry, as the phase difference spectrum ϕ(k), in the case of p=P, next to the fourth substep, and
the sixth substep of obtaining an argument range in the range in which Y(k) exists determined in the fourth substep as the search range of the fourth substep to be performed next, and obtaining the absolute value of the tangent of the argument representative value obtained in the fourth substep as the absolute value of the tangent of the argument representative value in the search range of the fourth substep to be performed next, setting a value obtained by adding 1 to p as new p, in the case of not p=P, next to the fourth substep.

5. The phase difference spectrum estimation method according to claim 1, wherein
the phase difference spectrum estimation step is performed by,
using P as a predetermined integer of 0 or more,
a first substep of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining an argument representative value in an argument range of the quadrant in which Y(k) exists,
a second substep of obtaining a complex value of a point on the circumference of the unit circle of which the argument of the complex plane is the argument representative value obtained in the first substep, of the phase difference spectrum representative values stored in the representative value storage circuitry, as the phase difference spectrum ϕ(k), in a case of p=P, next to the first substep,
a third substep of obtaining an argument range of the quadrant in which Y(k) exists as a search range of the next substep, setting 1 as new p, and obtaining an absolute value of a cotangent of the argument representative value in the search range, in a case of not p=P, next to the first substep,
a fourth substep of determining that Y(k) exists in a range on a real axis side in the search range obtained in the immediately preceding substep, and obtaining the argument representative value in the range on the real axis side in the search range obtained in the immediately preceding substep, in a case where |u(k)| is larger than a value obtained by multiplying |v(k)| by the absolute value of the cotangent of the argument representative value in the search range obtained in the immediately preceding substep, and determining that Y(k) exists in a range on an imaginary axis side in the search range obtained in the immediately preceding substep, and obtaining the argument representative value in the range on the imaginary axis side in the search range obtained in the immediately preceding substep, in a case where |u(k)| is smaller than the value obtained by multiplying |v(k)| by the absolute value of the cotangent of the argument representative value in the search range obtained in the immediately preceding substep,
a fifth substep of obtaining a complex value of a point on the circumference of the unit circle of which the argument of the complex plane is the argument representative value obtained in the fourth substep, of the phase difference spectrum representative values stored in the representative value storage circuitry, as the phase difference spectrum ϕ(k), in the case of p=P, next to the fourth substep, and
a sixth substep of obtaining an argument range in the range in which Y(k) exists determined in the fourth substep as the search range of the fourth substep to be performed next, and obtaining the absolute value of the cotangent of the argument representative value obtained in the fourth substep as the absolute value of the cotangent of the argument representative value in the search range of the fourth substep to be performed next, setting a value obtained by adding 1 to p as new p, in the case of not p=P, next to the fourth substep.

6. The phase difference spectrum estimation method according to claim 1, wherein
the phase difference spectrum estimation step is performed by,
using P as a predetermined integer of 0 or more,
a first substep of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining a median in an argument range of the quadrant in which Y(k) exists,
a second substep of obtaining a complex value of a point on the circumference of the unit circle of which the argument of the complex plane is the median obtained in the first substep, of the phase difference spectrum representative values stored in the representative value storage circuitry, as the phase difference spectrum ϕ(k), in a case of p=P, next to the first substep,
a third substep of obtaining an argument range of the quadrant in which Y(k) exists as a search range of the next substep, setting 1 as new p, in a case of not p=P, next to the first substep,
a fourth substep of, in a case of being performed next to the third substep, determining that Y(k) exists in a half range on a real axis side in the search range obtained in the third substep, and obtaining the argument representative value in the half range on the real axis side in the search range obtained in the third substep, in a case where |u(k)| is larger than |v(k)|, and determining that Y(k) exists in a half range on an imaginary axis side in the search range obtained in the third substep, and obtaining the argument representative value in the half range on the imaginary axis side in the search range obtained in the third substep, in a case where |u(k)| is smaller than |v(k)|, and,
in a case of being performed next to a sixth substep, determining that Y(k) exists in a range on a real axis side in the search range obtained in the sixth substep, and obtaining the argument representative value in the range on the real axis side in the search range obtained in the sixth substep, in a case where |u(k)| is larger than a value obtained by multiplying |v(k)| by the absolute value of the cotangent of the argument representative value in the search range obtained in the sixth substep, and determining that Y(k) exists in a range on an imaginary axis side in the search range obtained in the sixth substep, and obtaining the argument representative value in the range on the imaginary axis side in the search range obtained in the sixth substep, in a case where |u(k)| is smaller than the value obtained by multiplying |v(k)| by the absolute value of the cotangent of the argument representative value in the search range obtained in the sixth substep,
a fifth substep of obtaining a complex value of a point on the circumference of the unit circle of which the argument of the complex plane is the argument representative value obtained in the fourth substep, of the phase difference spectrum representative values stored in the representative value storage circuitry, as the phase difference spectrum ϕ(k), in the case of p=P, next to the fourth substep, and
the sixth substep of obtaining an argument range in the range in which Y(k) exists determined in the fourth substep as the search range of the fourth substep to be performed next, and obtaining the absolute value of the cotangent of the argument representative value obtained in the fourth substep as the absolute value of the cotangent of the argument representative value in the search range of the fourth substep to be performed next, setting a value obtained by adding 1 to p as new p, in the case of not p=P, next to the fourth substep.

7. The phase difference spectrum estimation method according to claim 1, wherein
the phase difference spectrum estimation step includes,
where N is an integer of 2 or more, π is each integer of 1 or more and N or less, and θ is the argument of Y(k),
in a case of (n−1)π/2N <θ<nπ/2N, obtaining a complex value of a point on the circumference of the unit circle of which the argument on the complex plane is (2n−1)π/4N among the phase difference spectrum representative values stored in the representative value storage circuitry, as the phase difference spectrum ϕ(k).

8. The phase difference spectrum estimation method according to claim 1, wherein
the phase difference spectrum estimation step includes,
where Q is an integer of 2 or more, q is each integer of 1 or more and Q or less, each representative value stored in the representative value storage circuitry is ϕ(q), and the argument of ϕ(q) on the complex plane is θ(ϕ(q)),
obtaining the representative value ϕ(q) corresponding to tan θ(ϕ(q)) having smallest |u(k)×tan θ(ϕ(q))−|v(k)| in value, as the phase difference spectrum ϕ(k).

9. An inter-channel relationship information estimation method including the phase difference spectrum estimation step of the phase difference spectrum estimation method according to claim 1, the inter-channel relationship information estimation method comprising:
a Fourier transform step of performing Fourier transform for each of the input signal of the first channel that is a sound signal in a time domain and the input signal of the second channel that is a sound signal in a time domain to obtain the frequency spectrum X₁(k) and the frequency spectrum X₂(k) for each frequency k from 0 to T−1;
the phase difference spectrum estimation step of obtaining the phase difference spectrum ϕ(k) for the each frequency k from 0 to T−1; and
an inter-channel relationship information acquisition step of
performing inverse Fourier transform of a sequence based on the phase difference spectra ϕ(0) to (T−1) for each candidate sample number τ_{cand} from a predetermined number τₘₐₓ to a predetermined number τₘᵢₙ to obtain a phase difference signal ψ(τ_{cand}) for the each candidate sample number τ_{cand} from τₘₐₓ to τₘᵢₙ,
obtaining a maximum value of a correlation value γ_{cand} that is an absolute value of the phase difference signal ψ(τ_{cand}), and
further performing at least one of
obtaining and outputting the maximum value of the correlation value γ_{cand} as an inter-channel correlation value γ,
obtaining and outputting τ_{cand} of when the correlation value γ_{cand} is the maximum value as an inter-channel time difference, or
in a case where τ_{cand} of when the correlation value γ_{cand} is the maximum value is a positive value, obtaining information indicating that the first channel is preceding as preceding channel information, or in a case where τ_{cand} of when the correlation value γ_{cand} is the maximum value is a negative value, obtaining information indicating that the second channel is preceding as preceding channel information, and outputting the obtained preceding channel information.

10. An inter-channel relationship information estimation method including the phase difference spectrum estimation step of the phase difference spectrum estimation method according to claim 2, the inter-channel relationship information estimation method comprising:
a Fourier transform step of performing Fourier transform for each of the input signal of the first channel that is a sound signal in a time domain and the input signal of the second channel that is a sound signal in a time domain to obtain the frequency spectrum X₁(k) and the frequency spectrum X₂(k) for each frequency k from 0 to T−1;
the phase difference spectrum estimation step of obtaining the phase difference spectrum ϕ(k) for the each frequency k from 0 to T−1; and
an inter-channel relationship information acquisition step of
performing inverse Fourier transform of a sequence based on the phase difference spectra ϕ(0) to ϕ(T−1) to each of which a weight that is a positive value is given for each candidate sample number τ_{cand} from a predetermined number τₘₐₓ to a predetermined number τₘᵢₙ to obtain a phase difference signal ψ(τ_{cand}) for the each candidate sample number τ_{cand} from τₘₐₓ to τₘᵢₙ,
obtaining a maximum value of a correlation value γ_{cand} that is an absolute value of the phase difference signal ψ(τ_{cand}), and
further performing at least one of
obtaining and outputting the maximum value of the correlation value γ_{cand} as an inter-channel correlation value γ,
obtaining and outputting τ_{cand} of when the correlation value γ_{cand} is the maximum value as an inter-channel time difference, or
in a case where τ_{cand} of when the correlation value γ_{cand} is the maximum value is a positive value, obtaining information indicating that the first channel is preceding as preceding channel information, or in a case where τ_{cand} of when the correlation value γ_{cand} is the maximum value is a negative value, obtaining information indicating that the second channel is preceding as preceding channel information, and outputting the obtained preceding channel information, wherein
a value of the P is predetermined for each frequency, and the value of P is smaller for a frequency with the weight that is smaller.

11. A signal encoding method comprising:
the phase difference spectrum estimation step of the phase difference spectrum estimation method according to claim 1; and
an encoding step of encoding the input signal of the first channel and the input signal of the second channel using the phase difference spectrum ϕ(k) obtained in the phase difference spectrum estimation step to obtain a signal code, and outputting the signal code.

12. A signal processing method comprising:
the phase difference spectrum estimation step of the phase difference spectrum estimation method according to claim 1; and
a signal processing step of processing the input signal of the first channel and the input signal of the second channel using the phase difference spectrum ϕ(k) obtained in the phase difference spectrum estimation step to obtain a signal processing result, and outputting the signal processing result.

13. A phase difference spectrum estimation device that estimates a phase difference spectrum ϕ(k) of a frequency spectrum X₁(k) of an input signal of a first channel and a frequency spectrum X₂(k) of an input signal of a second channel with respect to a frequency k, the phase difference spectrum estimation device comprising:
a phase difference spectrum estimation circuitry configured to select one of a plurality of phase difference spectrum representative values, the representative values being stored in a representative value storage circuitry, being values on a circumference of a unit circle of a complex plane, and being values having different arguments on the complex plane, on a basis of a relationship between a value of a real part u(k) and a value of an imaginary part v(k) of a product Y(k) of the frequency spectrum X₁(k) of the first channel and a complex conjugate ⁻X₂(k) of the frequency spectrum X₂(k) of the second channel, and obtain the selected representative value as the phase difference spectrum ϕ(k).

14. The phase difference spectrum estimation device according to claim 13, wherein
the phase difference spectrum estimation circuitry determines,
using P as a predetermined integer of 0 or more,
in which quadrant Y(k) exists,
obtains the phase difference spectrum representative value for the quadrant in which Y(k) exists among the phase difference spectrum representative values stored in the representative value storage circuitry, as the phase difference spectrum ϕ(k), when P=0, and
specifies an argument range in which Y(k) exists by performing a binary search in the argument range P times with respect to the quadrant in which Y(k) exists, and obtains the phase difference spectrum representative value for the specified argument range among the phase difference spectrum representative values stored in the representative value storage circuitry, as the phase difference spectrum ϕ(k), when P≠0.

15. The phase difference spectrum estimation device according to claim 13, wherein
the phase difference spectrum estimation circuitry performs,
using P as a predetermined integer of 0 or more,
a first subprocess of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining an argument representative value in an argument range of the quadrant in which Y(k) exists,
a second subprocess of obtaining a complex value of a point on the circumference of the unit circle of which the argument of the complex plane is the argument representative value obtained in the first subprocess, of the phase difference spectrum representative values stored in the representative value storage circuitry, as the phase difference spectrum ϕ(k), in a case of p=P, next to the first subprocess,
a third subprocess of obtaining an argument range of the quadrant in which Y(k) exists as a search range of the next subprocess, setting 1 as a new p, and obtaining an absolute value of a tangent of the argument representative value in the search range, in a case of not p=P, next to the first subprocess,
a fourth subprocess of determining that Y(k) exists in a range on a real axis side in the search range obtained in the immediately preceding subprocess, and obtaining the argument representative value in the range on the real axis side in the search range obtained in the immediately preceding subprocess, in a case where a value obtained by multiplying |u(k)| by the absolute value of the tangent of the argument representative value in the search range obtained in the immediately preceding subprocess is larger than |v(k)|, and determining that Y(k) exists in a range on an imaginary axis side in the search range obtained in the immediately preceding subprocess, and obtaining the argument representative value in the range on the imaginary axis side in the search range obtained in the immediately preceding subprocess, in a case where the value obtained by multiplying |u(k)| by the absolute value of the tangent of the argument representative value in the search range obtained in the immediately preceding subprocess is smaller than |v(k)|,
a fifth subprocess of obtaining a complex value of a point on the circumference of the unit circle of which the argument of the complex plane is the argument representative value obtained in the fourth subprocess, of the phase difference spectrum representative values stored in the representative value storage circuitry, as the phase difference spectrum ϕ(k), in the case of p=P, next to the fourth subprocess, and
a sixth subprocess of obtaining an argument range in the range in which Y(k) exists determined in the fourth subprocess as the search range of the fourth subprocess to be performed next, and obtaining the absolute value of the tangent of the argument representative value obtained in the fourth subprocess as the absolute value of the tangent of the argument representative value in the search range of the fourth subprocess to be performed next, setting a value obtained by adding 1 to p as new p, in the case of not p=P, next to the fourth subprocess.

16. The phase difference spectrum estimation device according to claim 13, wherein
the phase difference spectrum estimation circuitry performs,
using P as a predetermined integer of 0 or more,
a first subprocess of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining a median in an argument range of the quadrant in which Y(k) exists,
a second subprocess of obtaining a complex value of a point on the circumference of the unit circle of which the argument of the complex plane is the median obtained in the first subprocess, of the phase difference spectrum representative values stored in the representative value storage circuitry, as the phase difference spectrum ϕ(k), in a case of p=P, next to the first subprocess,
a third subprocess of obtaining an argument range of the quadrant in which Y(k) exists as a search range of the next subprocess, setting 1 as new p, in a case of not p=P, next to the first subprocess,
a fourth subprocess of, in a case of being performed next to the third subprocess, determining that Y(k) exists in a half range on a real axis side in the search range obtained in the third subprocess, and obtaining the argument representative value in the half range on the real axis side in the search range obtained in the third subprocess, in a case where |u(k)| is larger than |v(k)|, and determining that Y(k) exists in a half range on an imaginary axis side in the search range obtained in the third subprocess, and obtaining the argument representative value in the half range on the imaginary axis side in the search range obtained in the third subprocess, in a case where |u(k)| is smaller than |v(k)|, and,
in a case of being performed next to a sixth subprocess, determining that Y(k) exists in a range on a real axis side in the search range obtained in the sixth subprocess, and obtaining the argument representative value in the range on the real axis side in the search range obtained in the sixth subprocess, in a case where a value obtained by multiplying |u(k)| by the absolute value of the tangent of the argument representative value in the search range obtained in the sixth subprocess is larger than |v(k)|, and determining that Y(k) exists in a range on an imaginary axis side in the search range obtained in the sixth subprocess, and obtaining the argument representative value in the range on the imaginary axis side in the search range obtained in the sixth subprocess, in a case where the value obtained by multiplying |u(k)| by the absolute value of the tangent of the argument representative value in the search range obtained in the sixth subprocess is smaller than |v(k)|,
a fifth subprocess of obtaining a complex value of a point on the circumference of the unit circle of which the argument of the complex plane is the argument representative value obtained in the fourth subprocess, of the phase difference spectrum representative values stored in the representative value storage circuitry, as the phase difference spectrum ϕ(k), in the case of p=P, next to the fourth subprocess, and
the sixth subprocess of obtaining an argument range in the range in which Y(k) exists determined in the fourth subprocess as the search range of the fourth subprocess to be performed next, and obtaining the absolute value of the tangent of the argument representative value obtained in the fourth subprocess as the absolute value of the tangent of the argument representative value in the search range of the fourth subprocess to be performed next, setting a value obtained by adding 1 to p as new p, in the case of not p=P, next to the fourth subprocess.

17. The phase difference spectrum estimation device according to claim 13, wherein
the phase difference spectrum estimation circuitry performs,
using P as a predetermined integer of 0 or more,
a first subprocess of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining an argument representative value in an argument range of the quadrant in which Y(k) exists,
a second subprocess of obtaining a complex value of a point on the circumference of the unit circle of which the argument of the complex plane is the argument representative value obtained in the first subprocess, of the phase difference spectrum representative values stored in the representative value storage circuitry, as the phase difference spectrum ϕ(k), in a case of p=P, next to the first subprocess,
a third subprocess of obtaining an argument range of the quadrant in which Y(k) exists as a search range of the next subprocess, setting 1 as new p, and obtaining an absolute value of a cotangent of the argument representative value in the search range, in a case of not p=P, next to the first subprocess,
a fourth subprocess of determining that Y(k) exists in a range on a real axis side in the search range obtained in the immediately preceding subprocess, and obtaining the argument representative value in the range on the real axis side in the search range obtained in the immediately preceding subprocess, in a case where |u(k)| is larger than a value obtained by multiplying |v(k)| by the absolute value of the cotangent of the argument representative value in the search range obtained in the immediately preceding subprocess, and determining that Y(k) exists in a range on an imaginary axis side in the search range obtained in the immediately preceding subprocess, and obtaining the argument representative value in the range on the imaginary axis side in the search range obtained in the immediately preceding subprocess, in a case where |u(k)| is smaller than the value obtained by multiplying |v(k)| by the absolute value of the cotangent of the argument representative value in the search range obtained in the immediately preceding subprocess,
a fifth subprocess of obtaining a complex value of a point on the circumference of the unit circle of which the argument of the complex plane is the argument representative value obtained in the fourth subprocess, of the phase difference spectrum representative values stored in the representative value storage circuitry, as the phase difference spectrum ϕ(k), in the case of p=P, next to the fourth subprocess, and
a sixth subprocess of obtaining an argument range in the range in which Y(k) exists determined in the fourth subprocess as the search range of the fourth subprocess to be performed next, and obtaining the absolute value of the cotangent of the argument representative value obtained in the fourth subprocess as the absolute value of the cotangent of the argument representative value in the search range of the fourth subprocess to be performed next, setting a value obtained by adding 1 to p as new p, in the case of not p=P, next to the fourth subprocess.

18. The phase difference spectrum estimation device according to claim 13, wherein
the phase difference spectrum estimation circuitry performs,
using P as a predetermined integer of 0 or more,
a first subprocess of determining in which quadrant of the complex plane Y(k) is located on a basis of whether a sign of u(k) or u(k) is a positive value or a negative value and whether a sign of v(k) or v(k) is a positive value or a negative value, setting p=0, and obtaining a median in an argument range of the quadrant in which Y(k) exists,
a second subprocess of obtaining a complex value of a point on the circumference of the unit circle of which the argument of the complex plane is the median obtained in the first subprocess, of the phase difference spectrum representative values stored in the representative value storage circuitry, as the phase difference spectrum ϕ(k), in a case of p=P, next to the first subprocess,
a third subprocess of obtaining an argument range of the quadrant in which Y(k) exists as a search range of the next subprocess, setting 1 as new p, in a case of not p=P, next to the first subprocess,
a fourth subprocess of, in a case of being performed next to the third subprocess, determining that Y(k) exists in a half range on a real axis side in the search range obtained in the third subprocess, and obtaining the argument representative value in the half range on the real axis side in the search range obtained in the third subprocess, in a case where |u(k)| is larger than |v(k)|, and determining that Y(k) exists in a half range on an imaginary axis side in the search range obtained in the third subprocess, and obtaining the argument representative value in the half range on the imaginary axis side in the search range obtained in the third subprocess, in a case where |u(k)| is smaller than |v(k)|, and,
in a case of being performed next to a sixth subprocess, determining that Y(k) exists in a range on a real axis side in the search range obtained in the sixth subprocess, and obtaining the argument representative value in the range on the real axis side in the search range obtained in the sixth subprocess, in a case where |u(k)| is larger than a value obtained by multiplying |v(k)| by the absolute value of the cotangent of the argument representative value in the search range obtained in the sixth subprocess, and determining that Y(k) exists in a range on an imaginary axis side in the search range obtained in the sixth subprocess, and obtaining the argument representative value in the range on the imaginary axis side in the search range obtained in the sixth subprocess, in a case where |u(k)| is smaller than the value obtained by multiplying |v(k)| by the absolute value of the cotangent of the argument representative value in the search range obtained in the sixth subprocess,
a fifth subprocess of obtaining a complex value of a point on the circumference of the unit circle of which the argument of the complex plane is the argument representative value obtained in the fourth subprocess, of the phase difference spectrum representative values stored in the representative value storage circuitry, as the phase difference spectrum ϕ(k), in the case of p=P, next to the fourth subprocess, and
the sixth subprocess of obtaining an argument range in the range in which Y(k) exists determined in the fourth subprocess as the search range of the fourth subprocess to be performed next, and obtaining the absolute value of the cotangent of the argument representative value obtained in the fourth subprocess as the absolute value of the cotangent of the argument representative value in the search range of the fourth subprocess to be performed next, setting a value obtained by adding 1 to p as new p, in the case of not p=P, next to the fourth subprocess.

19. The phase difference spectrum estimation device according to claim 13, wherein
the phase difference spectrum estimation circuitry obtains,
where N is an integer of 2 or more, π is each integer of 1 or more and N or less, and 0 is the argument of Y(k),
in a case of (n−1)π/2N <θ<nπ/2N, a complex value of a point on the circumference of the unit circle of which the argument on the complex plane is (2n−1)π/4N among the phase difference spectrum representative values stored in the representative value storage circuitry, as the phase difference spectrum ϕ(k).

20. The phase difference spectrum estimation device according to claim 13, wherein
the phase difference spectrum estimation circuitry obtains,
where Q is an integer of 2 or more, q is each integer of 1 or more and Q or less, each representative value stored in the representative value storage circuitry is ϕ(q), and the argument of ϕ(q) on the complex plane is θ(ϕ(q)),
the representative value ϕ(q) corresponding to tan θ(ϕ(q)) having smallest |u(k)×tan θ(ϕ(q))−|v(k)| in value, as the phase difference spectrum ϕ(k).

21. An inter-channel relationship information estimation device including the phase difference spectrum estimation device according to claim 13 as a phase difference spectrum estimation circuitry, the inter-channel relationship information estimation device comprising:
a Fourier transform circuitry configured to perform Fourier transform for each of the input signal of the first channel that is a sound signal in a time domain and the input signal of the second channel that is a sound signal in a time domain to obtain the frequency spectrum X₁(k) and the frequency spectrum X₂(k) for each frequency k from 0 to T−1;
the phase difference spectrum estimation circuitry configured to obtain the phase difference spectrum ϕ(k) for the each frequency k from 0 to T−1; and
an inter-channel relationship information acquisition circuitry configured to
perform inverse Fourier transform of a sequence based on the phase difference spectra ϕ(0) to (T−1) for each candidate sample number τ_{cand} from a predetermined number τₘₐₓ to a predetermined number τₘᵢₙ to obtain a phase difference signal ψ(τ_{cand}) for the each candidate sample number τ_{cand} from τₘₐₓ to τₘᵢₙ,
obtain a maximum value of a correlation value γ_{cand} that is an absolute value of the phase difference signal ψ(τ_{cand}), and
further perform at least one of
obtaining and outputting the maximum value of the correlation value γ_{cand} as an inter-channel correlation value γ,
obtaining and outputting τ_{cand} of when the correlation value γ_{cand} is the maximum value as an inter-channel time difference, or
in a case where τ_{cand} of when the correlation value γ_{cand} is the maximum value is a positive value, obtaining information indicating that the first channel is preceding as preceding channel information, or in a case where τ_{cand} of when the correlation value γ_{cand} is the maximum value is a negative value, obtaining information indicating that the second channel is preceding as preceding channel information, and outputting the obtained preceding channel information.

22. An inter-channel relationship information estimation device including the phase difference spectrum estimation device according to claim 14 as a phase difference spectrum estimation circuitry, the inter-channel relationship information estimation device comprising:
a Fourier transform circuitry configured to perform Fourier transform for each of the input signal of the first channel that is a sound signal in a time domain and the input signal of the second channel that is a sound signal in a time domain to obtain the frequency spectrum X₁(k) and the frequency spectrum X₂(k) for each frequency k from 0 to T−1;
the phase difference spectrum estimation circuitry configured to obtain the phase difference spectrum ϕ(k) for the each frequency k from 0 to T−1; and
an inter-channel relationship information acquisition circuitry configured to
perform inverse Fourier transform of a sequence based on the phase difference spectra ϕ(0) to ϕ(T−1) to each of which a weight that is a positive value is given for each candidate sample number τ_{cand} from a predetermined number τₘₐₓ to a predetermined number τₘᵢₙ to obtain a phase difference signal p(τ_{cand}) for the each candidate sample number τ_{cand} from τₘₐₓ to τₘᵢₙ,
obtain a maximum value of a correlation value γ_{cand} that is an absolute value of the phase difference signal p(τ_{cand}), and
further perform at least one of
obtaining and outputting the maximum value of the correlation value γ_{cand} as an inter-channel correlation value γ,
obtaining and outputting τ_{cand} of when the correlation value γ_{cand} is the maximum value as an inter-channel time difference, or
in a case where τ_{cand} of when the correlation value γ_{cand} is the maximum value is a positive value, obtaining information indicating that the first channel is preceding as preceding channel information, or in a case where τ_{cand} of when the correlation value γ_{cand} is the maximum value is a negative value, obtaining information indicating that the second channel is preceding as preceding channel information, and outputting the obtained preceding channel information, wherein
a value of the P is predetermined for each frequency, and the value of P is smaller for a frequency with the weight that is smaller.

23. A signal encoding device comprising:
the phase difference spectrum estimation device according to claim 13 as a phase difference spectrum estimation circuitry; and further comprising:
an encoding circuitry configured to encode the input signal of the first channel and the input signal of the second channel using the phase difference spectrum ϕ(k) obtained in the phase difference spectrum estimation circuitry to obtain a signal code, and output the signal code.

24. A signal processing device comprising:
the phase difference spectrum estimation device according to claim 13 as a phase difference spectrum estimation circuitry; and further comprising:
a signal processing circuitry configured to process the input signal of the first channel and the input signal of the second channel using the phase difference spectrum ϕ(k) obtained in the phase difference spectrum estimation circuitry to obtain a signal processing result, and output the signal processing result.

25. A non-transitory computer-readable storage medium which stores a program for causing a computer to execute the phase difference spectrum estimation method according to claim 1.

26. A non-transitory computer-readable storage medium which stores a program for causing a computer to execute the inter-channel relationship information estimation method according to claim 9.

27. A non-transitory computer-readable storage medium which stores a program for causing a computer to execute the signal encoding method according to claim 11.

28. A non-transitory computer-readable storage medium which stores a program for causing a computer to execute the signal processing method according to claim 12.
